(19) United States
(12) Patent Application Publication
(10) Pub. No.: US 2020/0260079 A1
(43) Pub. Date: Aug. 13, 2020

(54) METHOD FOR ENCODING/DECODING IMAGE AND DEVICE THEREFOR

(71) Applicant: SAMSUNG ELECTRONICS CO., LTD.

(72) Inventors: Jung-hye MIN, Yongin-si (KR); Chan-yul KIM, Seongnam-si (KR); Sun-il LEE, Seoul (KR)

(73) Assignee: SAMSUNG ELECTRONICS CO., LTD., Suwon-si (KR)

(21) Appl. No.: 15/776,353

(22) PCT Filed: Nov. 23, 2016
(86) PCT No.: PCT/KR2016/013520

§ 371 Date: May 15, 2018

(51) Int. Cl. H04N 19/122; H04N 19/105; H04N 19/136; H04N 19/176

(52) U.S. Cl. CPC H04N 19/122; H04N 19/176; H04N 19/136; H04N 19/105

(57) ABSTRACT

Provided are an image decoding method, according to an embodiment, capable of obtaining a residual signal of an image from a bitstream, changing a ratio of sizes of adjacent first blocks among a plurality of first blocks including the residual signal based on block ratio information obtained from the bitstream, and decoding the residual signal based on the changed ratio, wherein the block ratio information indicates one of predetermined ratios to which the ratio of the sizes of the adjacent first blocks is changeable; and an image decoding device capable of performing the image decoding method. Provided are also an image encoding method, according to an embodiment, capable of being performed in an opposite or similar way to the image decoding method; and an image encoding device capable of performing the image encoding method.

### TECHNICAL FIELD

A method and device according to an embodiment are capable of encoding or decoding an image by using various types of data units included in the image.

### BACKGROUND ART

Image data is encoded according to a data compression standard, e.g., a codec according to the Moving Picture Expert Group (MPEG) standard, and is recorded on a recording medium in the form of a bitstream or transmitted via a communication channel.

With the development and supply of hardware for reproducing and storing high-resolution or high-quality image content, there is a growing need for a codec for effectively encoding or decoding the high-resolution or high-quality image content. Encoded image content may be reproduced by decoding it. Recently, methods of effectively compressing such high-resolution or high-quality image content have been implemented. For example, an efficient image compression method is performed by processing an image to be encoded in a certain way. Furthermore, various types of data units have been used to split an image so as to adaptively encode or decode the image.

### DESCRIPTION OF EMBODIMENTS

### Technical Problem

A ratio of sizes of data units previously determined should be changed adaptively with respect to an image during encoding or decoding of the image.

### Solution to Problem

A method of decoding an image according to an embodiment includes obtaining a residual signal of an image from a bitstream, changing a ratio of sizes of adjacent first blocks among a plurality of first blocks including the residual signal based on block ratio information obtained from the bitstream, and decoding the residual signal based on the changed ratio, wherein the block ratio information indicates one of predetermined ratios to which the ratio of the sizes of the adjacent first blocks is changeable.

A method of encoding an image according to an embodiment includes determining a residual signal of the image; changing a ratio of sizes of adjacent first blocks among a plurality of first blocks including the residual signal; and encoding the image by generating a bitstream including the residual signal and block ratio information based on the changed ratio, wherein the block ratio information indicates the changed ratio, wherein the block ratio information indicates one of predetermined ratios to which the ratio of the sizes of the adjacent first blocks is changeable.

A device for decoding an image according to an embodiment includes a signal obtainer configured to obtain a residual signal of the image from a bitstream; and a decoder configured to change a ratio of sizes of adjacent first blocks among a plurality of first blocks including the residual signal based on block ratio information obtained from the bitstream, and decode the residual signal based on the changed ratio, wherein the block ratio information indicates one of predetermined ratios to which the ratio of the sizes of the adjacent first blocks is changeable.

A device for encoding an image according to an embodiment includes an encoder configured to determine a residual signal of the image and change a ratio of sizes of adjacent first blocks among a plurality of first blocks including the residual signal; and a bitstream generator configured to generate a bitstream including the residual signal and block ratio information based on the changed ratio, wherein the block ratio information indicates the changed ratio of the sizes of the adjacent first blocks, wherein the block ratio information indicates one of predetermined ratios to which the ratio of the sizes of the adjacent first blocks is changeable.

### Advantageous Effects of Disclosure

In one embodiment, an encoding or decoding process may be performed adaptively to an image by changing high-frequency components to low-frequency components in a transform domain used in encoding or decoding the image.

### BRIEF DESCRIPTION OF DRAWINGS

FIG. 1A is a block diagram of an image decoding device capable of decoding an image by changing a ratio of sizes of blocks included in the image.

FIG. 1B is a block diagram of an image encoding device capable of encoding an image by changing a ratio of sizes of blocks included in the image.

FIG. 2 is a flowchart of a process of decoding an image by changing a ratio of sizes of first blocks, according to an embodiment.

FIG. 3A illustrates a process of changing a ratio of sizes of first blocks included in an image, according to an embodiment.

FIG. 3B illustrates various cases in which a ratio of sizes of first blocks is changeable, according to an embodiment.

FIG. 4 is a flowchart of a method of decoding an image by using size change information indicating whether a ratio of sizes of first blocks is to be changed, the method being performed by an image decoding device, according to an embodiment.

FIG. 5 is a flowchart of a method of obtaining size change information and block ratio information from a bitstream and using the size change information and the block ratio information in a decoding process, the method being performed by an image decoding device, according to an embodiment.

FIG. 6A illustrates a relation between first blocks, the sizes of which are to be changed and a second block including the first blocks, according to an embodiment.

FIG. 6B is a diagram illustrating a process in which sizes of first blocks included in a third block are changeable, according to an embodiment.

FIG. 7 is a flowchart of a process of encoding an image by changing a ratio of sizes of first blocks, according to an embodiment.

FIG. 8 is a flowchart of a method of encoding an image by determining whether a ratio of sizes of first blocks is to be changed and encoding the image by using the changed first blocks, the method being performed by an image encoding device, according to an embodiment.

FIG. 9 is a flowchart of a process of determining whether a ratio of sizes of first blocks is to be changed and generating a bitstream including block ratio information indicating the changed ratio of the sizes of the first blocks and size change information indicating whether the ratio of the sizes of the first blocks is to be changed during encoding of an image, the process being performed by an image encoding device, according to an embodiment.

FIG. 10 illustrates an operation of determining one or more coding units by splitting a current coding unit, according to an embodiment.

FIG. 11 illustrates an operation of determining one or more coding units by splitting a non-square coding unit, according to an embodiment.

FIG. 12 illustrates an operation of splitting a coding unit, based on at least one of block shape information and split shape information, according to an embodiment.

FIG. 13 illustrates a method of determining a predetermined coding unit from among an odd number of coding units, according to an embodiment.

FIG. 14 illustrates a processing order of a plurality of coding units determined by splitting a current coding unit, according to an embodiment.

FIG. 15 illustrates an operation of determining that a current coding unit is split into an odd number of coding units, when the coding units are not processable in a predetermined order, according to an embodiment.

FIG. 16 illustrates an operation of determining one or more coding units by splitting a first coding unit, according to an embodiment.

FIG. 17 illustrates that splitting methods of determining non-square second coding units by splitting a first coding unit are restricted when the second coding units satisfy a predetermined condition, according to an embodiment.

FIG. 18 illustrates an operation of splitting a square coding unit when split shape information indicates not to split the square coding unit into four square coding units, according to an embodiment.

FIG. 19 illustrates that a processing order of a plurality of coding units is variable depending on an operation of splitting a coding unit, according to an embodiment.

FIG. 20 illustrates an operation of determining a depth of a coding unit as the shape and size of the coding unit varies when a plurality of coding units are determined by recursively splitting the coding unit, according to an embodiment.

FIG. 21 illustrates depths of and part indices (PIDs) for distinguishing coding units, which are determinable based on the shapes and sizes of the coding units, according to an embodiment.

FIG. 22 illustrates that a plurality of coding units are determined based on a plurality of predetermined data units included in a picture, according to an embodiment.

FIG. 23 illustrates a processing block serving as a unit for determining a determination order of reference coding units included in a picture, according to an embodiment.

### BEST MODE

An image decoding method according to an embodiment includes obtaining a residual signal of an image from a bitstream, changing a ratio of sizes of adjacent first blocks among a plurality of first blocks including the residual signal based on block ratio information obtained from the bitstream, and decoding the residual signal based on the changed ratio, wherein the block ratio information indicates one of predetermined ratios to which the ratio of the sizes of the adjacent first blocks is changeable.

In one embodiment, the changing of the ratio of the sizes of the adjacent first blocks may include obtaining size change information indicating whether the ratio of the sizes of the adjacent first blocks is to be changed from the bitstream; and when the size change information indicates that the ratio of the sizes of the adjacent first blocks is to be changed, changing the ratio of the sizes of the adjacent first blocks based on the block ratio information.

In one embodiment, the block ratio information may be obtained from the bitstream when the size change information indicates that the ratio of the sizes of the adjacent first blocks is to be changed.

In one embodiment, the changing of the ratio of the sizes of the adjacent first blocks may include obtaining the block ratio information from the bitstream in units of second blocks each including the adjacent first blocks; and when the block ratio information indicates that a ratio of sizes of the adjacent first blocks included in each of the second blocks is to be changed, changing the ratio of the sizes of the adjacent first blocks included in each of the second blocks based on the block ratio information.

In one embodiment, the plurality of first blocks may be transformation units which are units for inversely transforming the residual signal.

In one embodiment, second blocks used in the method of decoding an image may be largest coding units, coding units, or prediction units each including the adjacent first blocks, or processing blocks including at least one of the largest coding units.

A method of encoding an image according to an embodiment includes determining a residual signal of the image; changing a ratio of sizes of adjacent first blocks among a plurality of first blocks including the residual signal; and encoding the image by generating a bitstream including the residual signal and block ratio information based on the changed ratio, wherein the block ratio information indicates the changed ratio, wherein the block ratio information indicates one of predetermined ratios to which the ratio of the sizes of the adjacent first blocks is changeable.

In one embodiment, the changing of the ratio of the sizes of the adjacent first blocks may include determining whether the ratio of the sizes of the adjacent first blocks is to be changed; and when it is determined that the ratio of the sizes of the adjacent first blocks is to be changed, changing the ratio of the sizes of the adjacent first blocks.

In one embodiment, the encoding of the image by generating the bitstream may include generating a bitstream including size change information indicating whether the ratio of the sizes of the adjacent first blocks is to be changed; and when it is determined that the ratio of the sizes of the adjacent first blocks is to be changed, encoding the image by generating a bitstream including the block ratio information.

In one embodiment, the changing of the ratio of the sizes of the adjacent first blocks may include when it is determined that a ratio of sizes of the adjacent first blocks included in each of second blocks is to be changed, changing the ratio of the sizes of the adjacent first blocks included in each of the second blocks based on the block ratio information; and generating the bitstream including the block ratio information in units of the second blocks each including the adjacent first blocks.

In one embodiment, the plurality of first blocks may be transformation units which are units for transforming or inversely transforming the residual signal.

In one embodiment, the second blocks may be largest coding units, coding units or prediction units including the adjacent first blocks, or processing blocks including at least one of the largest coding units.

A device for decoding an image according to an embodiment includes a signal obtainer configured to obtain a residual signal of the image from a bitstream;

and a decoder configured to change a ratio of sizes of adjacent first blocks among a plurality of first blocks including the residual signal based on block ratio information obtained from the bitstream, and decode the residual signal based on the changed ratio, wherein the block ratio information indicates one of predetermined ratios to which the ratio of the sizes of the adjacent first blocks is changeable.

A device for encoding an image according to an embodiment includes an encoder configured to determine a residual signal of the image and change a ratio of sizes of adjacent first blocks among a plurality of first blocks including the residual signal; and a bitstream generator configured to generate a bitstream including the residual signal and block ratio information based on the changed ratio, wherein the block ratio information indicates the changed ratio of the sizes of the adjacent first blocks, wherein the block ratio information indicates one of predetermined ratios to which the ratio of the sizes of the adjacent first blocks is changeable.

In one embodiment, non-transitory computer-readable recording medium having recorded thereon a computer program for executing the method of decoding an image may be provided.

### MODE OF DISCLOSURE

Advantages and features of the present disclosure and methods of achieving them will be apparent from embodiments set forth herein in conjunction with the accompanying drawings. However, the present disclosure is not limited to these embodiments and may be embodied in many different forms. These embodiments are merely provided so that this disclosure will be thorough and complete and will fully convey the scope of the present disclosure to those of ordinary skill in the art.

The terms used herein will be briefly described and then the present disclosure will be described in detail.

In the present disclosure, general terms that have been widely used nowadays are selected, if possible, in consideration of functions of the present disclosure, but non-general terms may be selected according to the intentions of technicians in the this art, precedents, or new technologies, etc. Some terms may be arbitrarily chosen by the present applicant. In this case, the meanings of these terms will be explained in corresponding parts of the present disclosure in detail. Thus, the terms used herein should be defined not based on the names thereof but based on the meanings thereof and the whole context of the present specification.

As used herein, the singular forms “a”, “an” and “the” are intended to include the plural forms as well, unless the context clearly indicates otherwise

It will be understood that when an element is referred to as including another element, the element can further include other elements unless mentioned otherwise. The term “unit” used herein should be understood as software or a hardware component, such as a FPGA or an ASIC, which performs certain functions. However, the term “unit” is not limited to software or hardware. The term “unit” may be configured to be included in an addressable storage medium or be configured to reproduce one or more processors. Thus, for example, the term “unit” may include components, such as software components, object-oriented software components, class components and task components, processes, functions, attributes, procedures, subroutines, segments of program code, drivers, firmware, microcode, a circuit, data, database, data structures, tables, arrays, and variables. Functions provided in components and “units” may be combined to obtain a small number of components and “units” or may be split into sub-components and “sub-units”.

Hereinafter, the term “image” should be understood to include a static image, such as a still image of a video, and a moving picture, i.e., a dynamic image which is a video.

The term “sample” should be understood as data allocated to an image sampling position, i.e., data to be processed. For example, pixel values of an image in a spatial domain and transformation coefficients in a transform domain may be samples. A unit including such at least one sample may be defined as a block.

Embodiments of the present disclosure will be described in detail below such that those of ordinary skill in the art can easily implement them. In the drawings, parts that are not related to clearly describing the present disclosure are omitted.

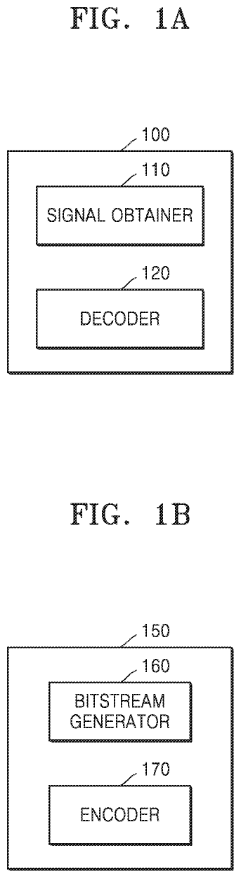

FIG. 1A is a block diagram of an image decoding device 100 capable of decoding an image by changing a ratio of sizes of blocks included in the image.

In one embodiment, the image decoding device 100 may include a signal obtainer 110 configured to obtain a residual signal from a bitstream, and a decoder 120 configured to decode an image by changing a ratio of sizes of first blocks including the residual signal. In detail, the decoder 120 of the image decoding device 100 may obtain block ratio information from the bitstream, and change a ratio of sizes of adjacent first blocks among the first blocks including the residual signal by using the block ratio information. Furthermore, the decoder 120 may reconstruct the image by decoding the residual signal based on the first blocks, the sizes of which are changed. Features of the image decoding device 100 will be described in detail with respect to various embodiments below.

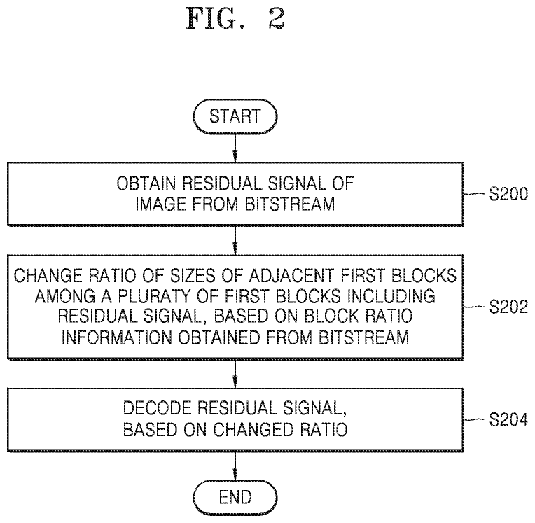

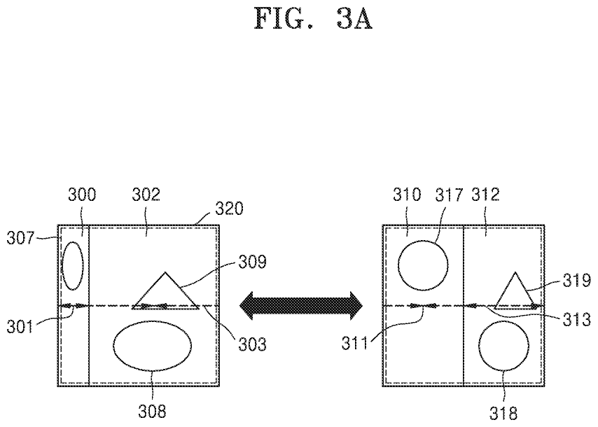

FIG. 2 is a flowchart of a process of decoding an image by changing a ratio of sizes of first blocks, according to an embodiment.

In one embodiment, in operation S200, the signal obtainer 110 may obtain a residual signal of an image from a bitstream. The residual signal obtained by the image decoding device 100 may include values of samples in a spatial domain reconstructed by inversely transforming and inversely quantizing information included in the bitstream.

In operation S202, the decoder 120 may change a ratio of sizes of adjacent first blocks among a plurality of first blocks including the residual signal based on block ratio information obtained from the bitstream. The block ratio information obtained from the bitstream may be information to be used for the decoder 120 to change a ratio of sizes of adjacent first blocks among a plurality of first blocks for splitting the image. In one embodiment, the block ratio information may include information for determining a ratio to which the ratio of the sizes of the first blocks is to be changed, and the ratio to which the ratio of the sizes of the first blocks is to be changed may be predetermined. In one embodiment, the decoder 120 may perform an image decoding process more adaptively to features of the image than in the related art by obtaining the residual signal from the bitstream and changing the ratio of the sizes of the first blocks including the residual signal. A process of changing the residual signal included in the first blocks by changing the ratio of the sizes of the first blocks will be described with respect to various embodiments below.

In operation S204, the decoder 20 of the image decoding device 100 may change values of samples of the residual signal according to a result of changing the ratio of the sizes of the first blocks, and decode the image by using the changed values of the samples. In one embodiment, the decoder 120 may perform an image decoding process using the values of the samples of the residual signal changed by changing the ratio of the sizes of the first blocks. In a process of decoding an image by using a residual signal which is a result of performing inverse transformation and inverse quantization, various decoding techniques, including a process of determining various types of data units, a prediction process performed according to an intra or inter prediction mode, filtering performed to reduce noise, etc., may be used. In one embodiment, when the values of the samples included in the first blocks are changed by changing the ratio of the sizes of the first blocks, the decoder 120 may use first blocks changed in various decoding processes as described above.

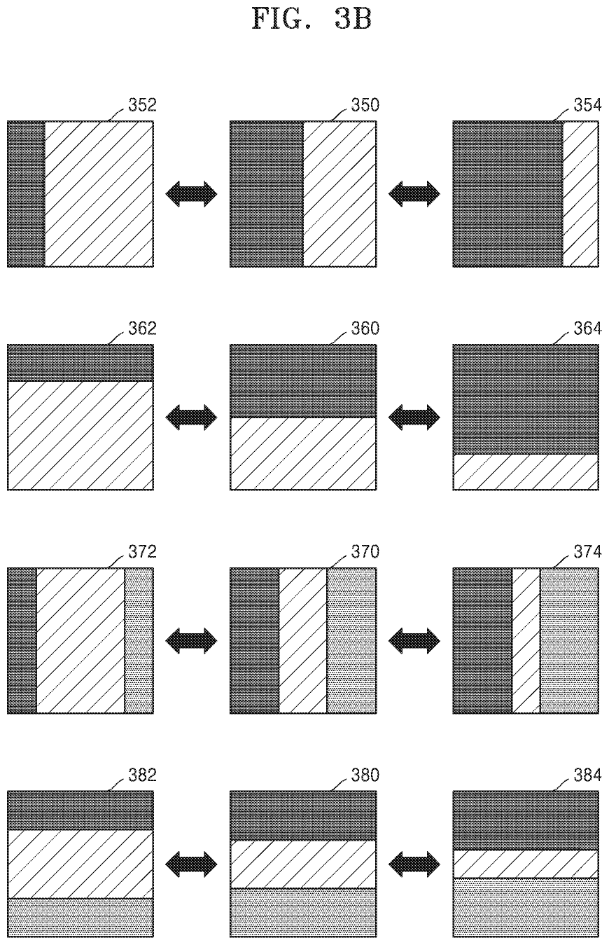

FIG. 3A illustrates a process of changing a ratio of sizes of first blocks included in an image, according to an embodiment.

In one embodiment, the image decoding device 100 may obtain a residual signal from a bitstream. The decoder 120 may change a ratio of sizes of first blocks including the residual signal. The decoder 120 may use block ratio information obtained from the bitstream to change the ratio of the sizes of the first blocks. Here, the block ratio information may be information indicating one of predetermined ratios to which the ratio of the sizes of adjacent first blocks among first blocks is changeable. Thus, the decoder 120 may change sizes of first blocks to be currently decoded by using the block ratio information obtained from the bitstream. That is, in order to reconstruct an image, the decoder 120 may perform a process of changing first blocks, which was performed by an encoding side, in a reverse order according to the block ratio information used in changing the sizes of the first blocks, as will be described in detail with respect to embodiments below.

Referring to FIG. 3A, the decoder 120 may determine first blocks 300 and 302 including the residual signal. The decoder 120 may decode the image based on the first blocks 300 and 302. Alternatively, in one embodiment, the decoder 120 may decode the image by using first blocks 310 and 312, the sizes of which are in a ratio obtained by changing a ratio of sizes of the first blocks 300 and 302. That is, when the ratio of the sizes of the first blocks 300 and 302 including the residual signal is to be changed, shapes of or a ratio of sizes of objects 307, 308, and 309 included in the first blocks 300 and 302 and related to the residual signal included in the first blocks 300 and 302 may be changed. Objects 317, 318, and 319 included in the first blocks 310 and 312, the sizes of which are in the changed ratio may be different in shape from the objects 307, 308, and 309 included in the first blocks 300 and 302.

It may be inefficient to perform the same compression process on a part of an image having more high-frequency components and a part of the image having less high-frequency components according to features of the image. In one embodiment, the image may be efficiently decoded by converting the high-frequency components to low-frequency components by adjusting a ratio of the part having the more high-frequency components. In one embodiment, the decoder 120 may decrease the size of the first block 302 having more high-frequency components among the first blocks 300 and 302 (as indicated by reference numeral 303). Thus, the size of the first block 300 adjacent to the first block 302 having the more high-frequency components may be increased (as indicated by reference numeral 301). As the size of the first block 302 having the more high-frequency components is decreased (as indicated by reference numeral 303), the size of the first block 302 increased to efficiently encode the high-frequency components included therein (as indicated by reference numeral 313) may be decreased (as indicated by reference numeral 303). Thus, the objects 308 and 309 included in the first block 302 related to the residual signal obtained from the bitstream may be changed again to the objects 318 and 319 included in the first block 312 to which the first block 302 is changed. That is, the decoder 120 may change the ratio of the size of the first block 302 by performing a process of increasing the size of the first block 302, which was performed to encode the high-frequency components (as indicated by reference numeral 313), in a reverse order.

In one embodiment, the decoder 120 may change the ratio of the sizes of the first blocks 300 and 302 included in a data block. Referring to FIG. 3A, the image decoding device 100 may decode the image by using various types of data blocks. The decoder 120 may use other various types of data blocks, as well as the first blocks 300 and 302 for processing the residual signal. Some of the data blocks may be included in each other. In one embodiment, the decoder 120 may decode the image by using a second block 320 including the first blocks 300 and 302.

In one embodiment, the decoder 120 may change the ratio of the sizes of the first blocks 300 and 302 included in the second block 320. That is, the decoder 120 may determine the ratio of the sizes of the first blocks 300 and 302 included in the second block 320, based on the block ratio information obtained from the bitstream. In one embodiment, the block ratio information may be information indicating a ratio to which the size of the first block 300 included in the second block 320 is increased (as indicated by reference numeral 301) or a ratio to which the size of the first block 302 included in the second block 320 is decreased (as indicated by reference numeral 303).

FIG. 3B illustrates various cases in which a ratio of sizes of first blocks is changeable, according to an embodiment.

Referring to FIG. 3B, in one embodiment, the decoder 120 may change a ratio of sizes of first blocks, based on block ratio information obtained from a bitstream. The ratio of the sizes of the first blocks may be changed in consideration of a size of a second block which is included in the first blocks. For example, the decoder 120 may decode an image by using a second block 350 including two vertically long first blocks, a second block 360 including two horizontally long first blocks, a second block 370 including three vertically long first blocks, and a second block 380 including three horizontally long first blocks. In one embodiment, block shape information obtained from the bitstream may indicate a ratio of sizes to which the ratio of the sizes of the first blocks is to be changed, based on the shapes of the first blocks included in the second blocks 350, 360, 370, and 380. For example, the decoder 120 may determine shapes of first blocks included in a current second block, and determine one of the shapes of the first blocks to be changed in relation to the current second block, based on the block ratio information.

Referring to FIG. 3B, the decoder 120 may determine the shapes of the first blocks included in the current second block. For example, the decoder 120 may determine that a current second block 350, 352 or 354 includes two vertically long first blocks. The decoder 120 may change a ratio of sizes of the first blocks included in the current second block 350, 352 or 354, based on the block shape information obtained from the bitstream. For example, when the current second block 352 includes two vertically long first blocks and a width of the right first block is greater than that of the other first block among the two first blocks, the decoder 120 may decrease the width of the right first block to change the current second block 352 having the two asymmetric first blocks to the second block 350 including two symmetric first blocks having the same width, based on the block ratio information. As another example, when the current second block 362 includes two horizontally long first blocks and a height of the lower first block is greater than that of the other first blocks among the two first blocks, the decoder 120 may decrease the height of the higher first block to change the current second block 362 having two asymmetric first blocks to the second block 360 including two symmetric first blocks having the same height, based on the block ratio information. Similarly, a ratio of sizes of first blocks included in each of second blocks having various shapes corresponding to the above-described embodiment (e.g., the second block 354 having a left first block wider than a right first block, a second block 364 having an upper first block longer than a lower first block, etc.) may be changed as described above.

In one embodiment, a second block may include an odd number of first blocks. Referring to FIG. 3B, the decoder 120 may decode the image by using the second block 370, 372 or 374 including an odd number of vertically long first blocks or a second block 380, 382 or 384 including an odd number of horizontally long first blocks.

Referring to FIG. 3B, the decoder 120 may determine that the current second block 370, 372 or 374 includes an odd number of vertically long first blocks (e.g., three first blocks). The decoder 120 may change a ratio of sizes of the first blocks included in the current second block 370, 372 or 374, based on the block shape information obtained from the bitstream. For example, when the current second block 372 includes three vertically long first blocks and a width of the central first block is greater than those of the other first blocks among the three first blocks, the decoder 120 may decrease the width of the central first block based on the block ratio information and use the second block 370 having three first blocks having the same width to decode the image. As another example, when the current second block 382 includes three horizontally long first blocks and a height of the central first block is greater than those of the other first blocks among the three first blocks, the decoder 120 may decrease the height of the higher central first block based on the block ratio information and use the second block 380 having three first blocks having the same height to decode the image. Similarly, a ratio of first blocks included in each of second blocks having various shapes corresponding to the above-described embodiment (e.g., the second block 374 having a central first block narrower than other first blocks, the second block 384 having a central first block shorter than the other first blocks, etc.) may be changed as described above.

For convenience of explanation, the process of changing a ratio of sizes of first blocks which may be determined by the image decoding device 100 has been described above with respect to the first blocks illustrated in FIG. 3B. However, shapes to which shapes of first blocks are to be changed should not be construed as being limited to those described above with reference to FIG. 3B, and the decoder 120 may perform a process of changing a ratio of sizes of first blocks included in second blocks having various shapes (e.g., square or rectangular blocks).

In one embodiment, the decoder 120 may change a ratio of sizes of first blocks included in a second block, based on at least one of partition information of the second block and the block ratio information which are obtained from a bitstream.

In one embodiment, the decoder 120 may obtain partition information, which is information regarding a shape of at least one block included in a second block, from a bitstream. For example, the decoder 120 may obtain partition information indicating various shapes, such as 2N×2N, 2N×N, N×2N, N×N, nL×2N, nR×2N, 2N×nU, and 2N×nD, of at least one block included in a 2N×2N second block from the bitstream. The decoder 120 may determine sizes of first blocks included in a current second block based on the partition information obtained from the bitstream, and change a ratio of the sizes of the first blocks included in the current second block by using the determined shapes of the first blocks and the block ratio information. For example, when the decoder 120 obtains partition information indicating 2N×2N or N×N from the bitstream, the process of changing the ratio of the sizes of the first blocks may be skipped. When the partition information indicating 2N×2N or N×N is obtained from the bitstream, the decoder 120 may increase or decrease a height or width of a first block among first blocks included in the second block to change a ratio of sizes of the first blocks to nL×2N, nR×2N, 2N×nU, or 2N×nD. When the partition information indicating nL×2N, nR×2N, 2N×nU, and 2N×nD is obtained from the bitstream, the decoder 120 may perform a process of changing first blocks by increasing or decreasing a height or width of a first block to 2N×N or N×2N among the first blocks included in the second block. However, shapes of partitions indicated by the partition information described above are merely examples for convenience of explanation, and various shapes of first blocks included in a second block may be determined based on the partition information.

In one embodiment, when values of samples included in a first block are changed by increasing or decreasing a size of the first block, interpolation or sampling may be performed on the values of the samples. For example, the decoder 120 may change the values and number of the samples included in the first block by interpolating the values of the samples when the size of the first block is increased.

Furthermore, the decoder 120 may change the values and number of the samples included in the first block by sampling the values of the samples when the size of the first block is decreased.

In one embodiment, the decoder 120 may determine shapes of first blocks included in a second block by obtaining block ratio information from a bitstream, and determine whether sizes of the first blocks are to be changed. For example, the block ratio information obtained from the bitstream by the image decoding device 100 may indicate information shown in Table 1 below.

TABLE 1

| | | Whether size of first block |
|---|---|---|
| Block ratio | Shape of | is to be changed, and shape |
| information | first block | of changed first block |
| 0000 | 2N × 2N | 2N × 2N |
| 0001 | N × N | N × N |
| 0010 | 2N × N | 2N × nU |
| 0011 | | 2N × N |
| 0100 | N × 2N | nL × 2N |
| 0101 | | N × 2N |
| 0110 | nL × 2N | N × 2N |
| 0111 | | nL × 2N |
| 1000 | nR × 2N | N × 2N |
| 1001 | | nR × 2N |
| 1010 | 2N × nU | 2N × N |
| 1011 | | 2N × nU |
| 1100 | 2N × nD | 2N × N |
| 1101 | | 2N × nD |

The decoder 120 obtaining the block ratio information may determine shapes of first blocks included in a current second block according to Table 1 above, and determine whether sizes of the determined shapes of the first blocks are to be changed. That is, the decoder 120 may determine shapes of blocks based on which a residual signal has been encoded and obtained from a bitstream by the decoder 120, determine whether the sizes of the determined shapes of the first blocks are to be changed, and determine a ratio of the sizes of the first block to be changed based on the block ratio information.

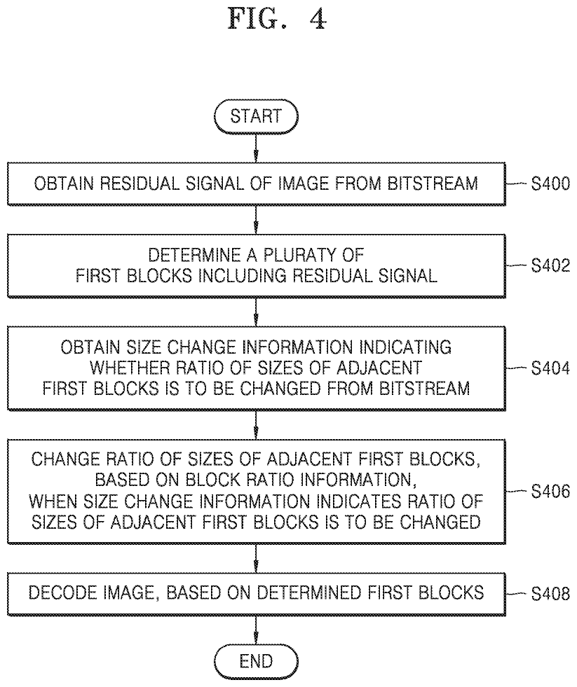

FIG. 4 is a flowchart of a method of decoding an image by using size change information indicating whether a ratio of sizes of first blocks is to be changed, the method being performed by the image decoding device 100, according to an embodiment. In one embodiment, the size change information may be defined as information indicating whether a ratio of sizes of adjacent first blocks is to be changed.

In one embodiment, the decoder 120 may obtain a residual signal of an image from a bitstream in operation S400, and determine first blocks including the residual signal in operation S402.

In one embodiment, in operation S404, the decoder 120 may obtain size change information indicating whether a ratio of sizes of first blocks is to be changed from a bitstream. In one embodiment, the size change information may be obtained from the bitstream in units of data units each including first blocks. For example, the decoder 120 may obtain size change information from the bitstream in units of second blocks each including at least one first block, and determine whether a ratio of a size of the at least one first block included in each of the seconds blocks is to be changed. That is, in one embodiment, the decoder 120 may determine whether sizes of first blocks are to be changed in units of the second blocks based on the size change information and may thus determine whether an additional data processing process is to be performed, adaptively to features of the image. In one embodiment, in operation S406, the decoder 120 may change sizes of first blocks, the sizes of which are determined to be changed, based on the block ratio information.

In one embodiment, in operation S408, the decoder 120 may decode the image, based on at least one of the first blocks, the sizes of which are changed. The decoder 120 may change the sizes of the first blocks by performing a size change process, which was performed by an encoding side, in a reverse order, and perform an image reconstructing process using the changed first blocks. The decoder 120 may perform a prediction process and the image reconstructing process using values of samples included in the changed first blocks.

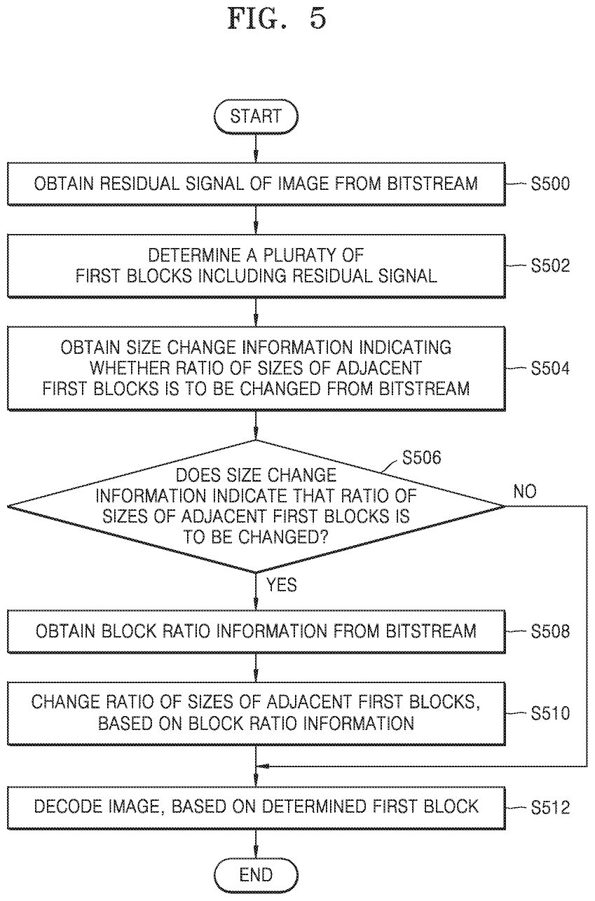

FIG. 5 is a flowchart of a method of obtaining size change information and block ratio information from a bitstream and using the size change information and the block ratio information in a decoding process, the method being performed by the image decoding device 100, according to an embodiment. In one embodiment, the decoder 120 may perform operations S500 to S504 of FIG. 5 in the same way as operations S400 to S404 of FIG. 4.

In one embodiment, in operation S506, the decoder 120 may determine whether size change information indicates whether a ratio of sizes of first blocks is to be changed. In one embodiment, the decoder 120 may obtain the size change information from a bitstream in units of data units each including at least one first block. For convenience of explanation, it will be assumed below that the data units are second blocks used in the various embodiments described above.

In one embodiment, the decoder 120 may obtain the size change information from the bitstream in units of second blocks each including at least one first block. The decoder 120 may determine whether a size of the at least one first block included in each of the second blocks is to be changed, based on the size change information obtained in units of the second blocks.

In one embodiment, in operation S512, when the size change information indicates that the at least one first block included in each of the second blocks is not to be changed, the decoder 120 may decode an image, based on the at least one first block. That is, in one embodiment, when size change information obtained from a bitstream in relation to a current second block indicates that at least one first block included in the current second block is not to be changed, a process of obtaining block ratio information from the bitstream may be skipped. The decoder 120 may obtain the block ratio information in units of data units (e.g., second blocks) each including at least one first block. However, when a size of the at least one first block included in each of the data units is not to be changed, the block ratio information may not be used in a decoding process. Thus, before the block ratio information is obtained from the bitstream, the decoder 120 may determine whether the block ratio information is to be obtained from the bitstream by determining whether the size of the at least one first block is to be changed based on the size change information.

In one embodiment, in operation S508, when the size change information indicates that the size of the at least one first block included in each of the second blocks is to be changed, the decoder 120 may obtain block ratio information indicating one of predetermined ratios to which the ratio of the sizes of the first blocks is to be changed from the bitstream. In operation S510, the decoder 120 may change a ratio of sizes of adjacent first blocks included in each of the second blocks, based on the block ratio information. The predetermined ratios to which the ratio of the sizes of the first blocks is to be changed will be apparent from various embodiments set forth herein.

In one embodiment, the decoder 120 may change the sizes of the first blocks in operation S510, and decode the image based on the changed first blocks in operation S512.

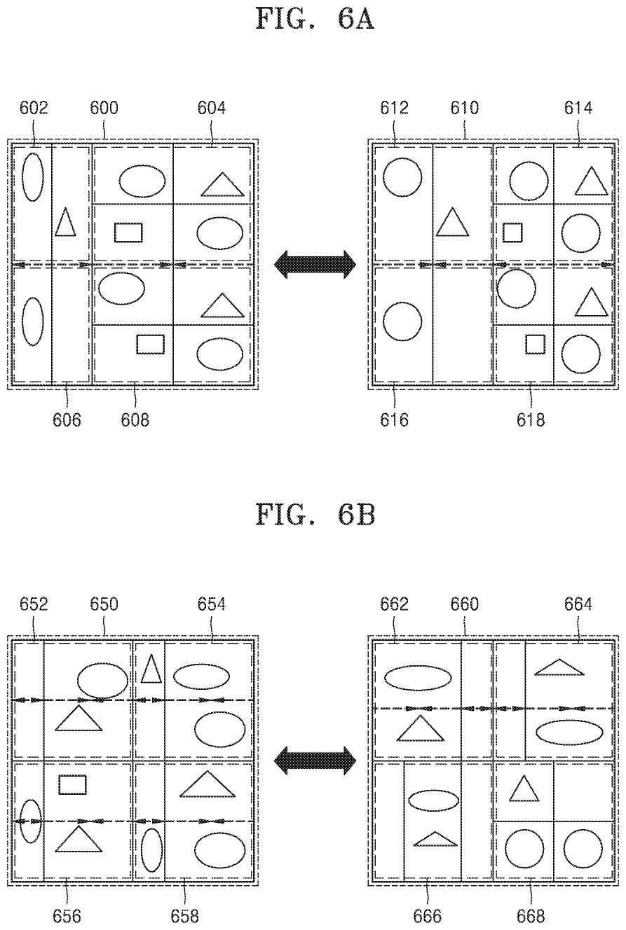

FIG. 6A illustrates a relation between first blocks, the sizes of which are to be changed and a second block including the first blocks, according to an embodiment.

In one embodiment, the decoder 120 may determine whether a size of at least one first block included in a second block is to be changed, and change the size of the at least one first block based on a data unit which may include at least one second block. For example, the decoder 120 may change sizes of first blocks included in at least one second block based on a data block, such as a slice, a slice segment, etc, which may include at least one second block. For convenience of explanation, a data unit including at least one second block will be hereinafter defined as a third block.

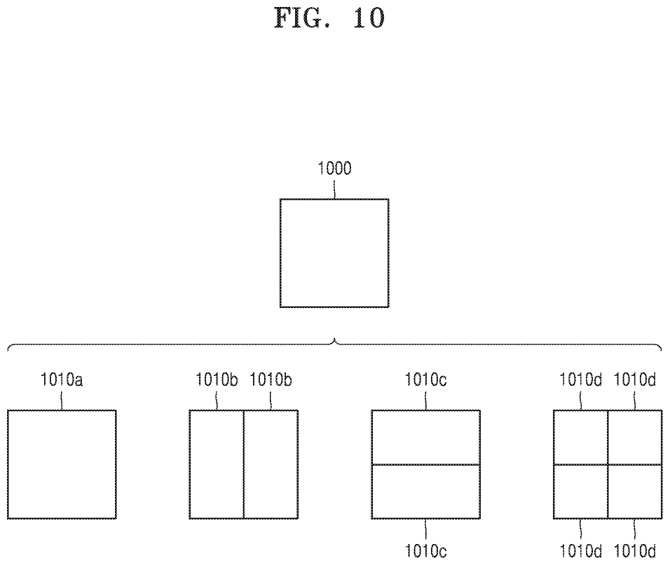

In one embodiment, the decoder 120 may use a first block, a second block and a third block which are in an inclusion relation with each other as data blocks available in a process of decoding an image. In one embodiment, when the first block is a transformation unit, the second block may include a largest coding unit, a coding unit, or a prediction unit which may include the transformation unit, and the third block may be defined as a picture, a largest coding unit, or a coding unit which may include the second block. For convenience of explanation, it will be assumed in embodiments related to FIGS. 6A and 6B that a first block is a transformation unit, a second block is a coding unit, and a third block is a largest coding unit. In one embodiment, an image decoding method using largest coding units, coding units, transformation units, etc. included in various data units as described above will be described with reference to FIGS. 10 to 23 below.

Referring to FIG. 6A, the decoder 120 may change sizes of first blocks by using second blocks 602, 604, 606, and 608 which may each include at least one first block. Furthermore, the decoder 120 may change sizes of first blocks included in the second blocks 602, 604, 606, and 608, based on at least one third block 600 including the second blocks 602, 604, 606, and 608. In detail, the decoder 120 may obtain size change information indicating whether sizes of first blocks are to be changed from a bitstream in units of third blocks. When the size change information indicates that the sizes of the first blocks are to be changed, the sizes of the first blocks may be changed based on the second blocks 602, 604, 606, and 608 including the first blocks. Referring to FIG. 6A, in one embodiment, the size change information may be obtained from the bitstream in units of third blocks, and the decoder 120 may determine whether the sizes of the first blocks included in the second blocks 602, 604, 606, and 608 included in the at least one third block 600, based on the size change information. Referring to FIG. 6A, in order to change the sizes of the first blocks included in the at least one third block 600, widths of the first blocks included in the left second blocks 602 and 606 may be increased and widths of the right second blocks 604 and 608 may be decreased among the second blocks 602, 604, 606, and 608. That is, the decoder 120 may determine whether sizes of first blocks included in one second block are to be changed and determine sizes to which the sizes of the first blocks are to be changed, and determine sizes of first blocks in units of third blocks each including second blocks.

In one embodiment, the decoder 120 may obtain size change information and block ratio information of each of different data units from a bitstream. For example, the decoder 120 may determine whether a size of at least one of first blocks included in each of the at least one third block 600 is to be changed by obtaining size change information of each of the at least one third block 600 from a bitstream. Furthermore, when the size change information obtained in relation to each of the at least one third block 600 indicates that the size of the at least one first block is to be changed, block ratio information indicating one of predetermined ratios to which a ratio of sizes of first blocks is to be changed may be obtained from the bitstream for each of the second blocks 602, 604, 606, and 608 included in the at least one third bock 600. The decoder 120 may determine whether first blocks are to be changed and determine sizes to which sizes of the first blocks are to be changed, based on the block ratio information obtained for each of the second blocks 602, 604, 606, and 608. That is, the size change information is obtained for each of the at least one third block 600, and thus the block ratio information need not be obtained from the bitstream for each of the second blocks 602, 604, 606, and 608 when sizes of all the first blocks included in the at least one third block 600 are not to be changed. Accordingly, the bitstream may be efficiently used.

In one embodiment, first blocks, second blocks 612, 614, 616, and 618, and a third block 610 may be used and a process of changing sizes of the first blocks may be performed in a process of encoding the image. In the process of encoding the image, in order to change the sizes of the first blocks based on the first blocks, the second blocks 602, 604, 606, and 608 and the third block 600, the process of changing the sizes of the first blocks may be performed in a similar or opposite way to the operation of the image decoding device 100 described above. That is, the image decoding device 100 may perform a process of changing sizes of first blocks which is reverse to a compression process performed by an encoding side, and may generate a reconstruction signal related to a signal used before the image has been encoded using first blocks having changed sizes.

FIG. 6B is a diagram illustrating a process in which sizes of first blocks included in a third block are changeable, according to an embodiment.

In one embodiment, the decoder 120 may determine that methods of changing sizes of first blocks included in each of second blocks 652, 654, 656, and 658 are the same. That is, the decoder 120 may obtain size change information for each of third blocks 650 each including the second blocks 652, 654, 656, and 658 from a bitstream. Furthermore, the decoder 120 may obtain block ratio information for each of the third blocks 650 from the bitstream, and change the sizes of the first blocks included in the second blocks 652, 654, 656, and 658 based on the block ratio information. In one embodiment, the decoder 120 may change the sizes of the first blocks included in each of the second blocks 652, 654, 656, and 658 based on the size change information and the block ratio information obtained for each of the third blocks 650, and determine that methods of changing the sizes of the first blocks included in each of the second blocks 652, 654, 656, and 658 are the same.

In one embodiment, the decoder 120 may determine that a method of changing sizes of first blocks included in each of second blocks 662, 664, 666, and 668 is different from methods of changing the sizes of the first blocks included in the other second blocks. In one embodiment, the decoder 120 may change the sizes of the first blocks included in each of second blocks 662, 664, 666, and 668 based on size change information and block ratio information obtained for each of third blocks 660. In this case, a process of changing the sizes of the first blocks included in each of the second blocks 662, 664, 666, and 668 may be different from processes of changing the sizes of the first blocks included in the other second blocks. Referring to FIG. 6B, each of the second blocks 662, 664, 666, and 668 included in each of the third blocks 660 includes first blocks. The decoder 120 may obtain block ratio information for each of the third blocks 660 from the bitstream and thus may determine sizes of the first blocks which are included in each of the third blocks 660 and which are to be changed (or may determine a process of changing the sizes of the first blocks). That is, the block ratio information obtained for each of the third blocks 660 may be defined such that various processes of changing the sizes of the first blocks are performed on the second blocks 662, 664, 666, and 668 included in each of the third blocks 660.

In one embodiment, operations of the signal obtainer 110 and the decoder 120 described above may be performed by one decoder 120 or a processor (CPU).

In another embodiment, a first block, the size of which may be changed by the image decoding device 100 may include residual information or a reconstructed signal which is a result of performing a reconstruction process using the residual information. That is, a residual signal included in the first block, the size of which is changed may correspond to the difference between values of the reconstructed signal and a predicted signal and may include a reconstructed signal which is a result of performing the reconstruction process using the residual signal. In the various embodiments described above, the image decoding device 100 may perform an image decoding process by changing the reconstructed signal included in the first block by changing the first block. That is, in one embodiment, the first block may be a data unit (e.g., a coding unit) including the reconstructed signal, and the image decoding device 100 may change a size of the data unit including the reconstructed signal according to the various embodiments described above. Thus, when a signal included in the first block is the reconstructed signal, the decoder 120 may reconstruct an image by determining the reconstructed signal by using a data unit (e.g., a transformation unit) for reconstructing the residual signal and changing a size of the first block including the reconstructed signal to change a value of the reconstructed signal included in the first block. In one embodiment, a process of changing the reconstructed signal of the first block may correspond to a process of changing the residual signal included in the first block and is thus not described in detail here.

The various embodiments described above include features which may be used for the image decoding device 100 to decode the image. Features which may be used for an image encoding device 150 to encode the image according to various embodiments related to a decoding process performed by the image decoding device 100 will be described below.

FIG. 1B is a block diagram of the image encoding apparatus 150 capable of encoding an image by changing a ratio of sizes of blocks included in the image.

In one embodiment, the image encoding device 150 may include a bitstream generator 160 configured to generate a bitstream including a residual signal, and an encoder 170 configured to encode an image by changing a ratio of sizes of first blocks including the residual signal. In detail, the encoder 170 of the image encoding device 150 may change a ratio of sizes of adjacent first blocks among the first blocks including the residual signal. Furthermore, the encoder 170 may encode the image by using the residual signal, based on the first blocks, the sizes of which are changed. Characteristics of the image encoding device 150 will be described in detail with respect to various embodiments below.

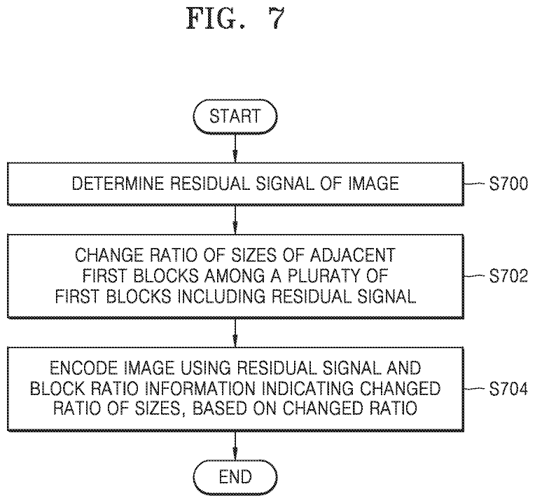

FIG. 7 is a flowchart of a process of encoding an image by changing a ratio of sizes of first blocks, according to an embodiment.

In one embodiment, in operation S700, the encoder 170 may determine a residual signal of an image. In one embodiment, the residual signal may correspond to the difference between values of an original signal and a predicted signal, the encoder 170 may transform and quantize the residual signal, and the bitstream generator 160 may generate a bitstream related to a result of inversely quantizing the residual signal.

In operation S702, the encoder 170 may change a ratio of sizes of adjacent first blocks among first blocks including the residual signal. In one embodiment, the encoder 170 may perform a process of encoding an image more adaptively to features of the image than that in the related art by changing the ratio of the sizes of the first blocks. A process of changing the residual signal included in the first blocks by changing the ratio of the sizes of the first blocks will be described with respect to various embodiments below.

In operation S704, the encoder 170 may encode the residual signal, based on a result of changing the ratio of the sizes of the first blocks. The encoder 170 may encode the image by using the residual signal changed by changing the ratio of the sizes of the first blocks. In the encoding of the image by using the residual signal, various encoding techniques, including a process of determining various types of data units, a prediction process performed according to an intra or inter prediction mode, a transformation and quantization process performed in a transform domain, filtering performed to decrease noise, etc., may be used. In one embodiment, the bitstream generator 160 may generate a bitstream including block ratio information indicating a ratio of sizes of first blocks which is one of predetermined ratios and a residual signal.

FIG. 3A illustrates a process of changing a ratio of sizes of first blocks included in an image, according to an embodiment.

In one embodiment, the encoder 170 may change a ratio of sizes of first blocks including a residual signal, and the bitstream generator 160 may generate a bitstream including block ratio information indicating the changed ratio of sizes of the first blocks. Here, the block ratio information may be information indicating one of predetermined ratios to which a ratio of sizes of adjacent first blocks among first blocks may be changed. Thus, the encoder 170 may change a size of at least one first block included in an image to be currently encoded by using the block ratio information obtained from the bitstream. That is, the encoder 170 changes the sizes of the first blocks, and the bitstream generator 160 generates the bitstream including the block ratio information indicating information regarding the changed sizes of the first blocks. Accordingly, in a decoding process, the decoder 120 may perform the process of changing the sizes of the first blocks, which was performed by the encoder 170, in a reverse order to reconstruct the image. The feature of the decoder 120 has been described above with respect to various embodiments and is thus not described in detail here.

Referring to FIG. 3A the encoder 170 may determine first blocks 310 and 312 for splitting the image. The encoder 170 may encode the image, based on the first blocks 310 and 312. Alternatively, in one embodiment, the encoder 170 may encode the image by using first blocks 300 and 302 having sizes which are in a ratio obtained by changing a ratio of sizes of the first blocks 310 and 312. That is, when the ratio of the sizes of the first blocks 310 and 312 including a residual signal is changed, shapes or a ratio of sizes of objects 317, 318, and 319 which are related to the residual signal included in the first blocks 310 and 312 and which are included in the first blocks 310 and 312 may be changed. Shapes of objects 307, 308, and 309 included in the first blocks 300 and 302 which are in the changed ratio of the sizes thereof may be different from those of objects 317, 318, and 319 included in the first blocks 310 and 312, the ratio of the sizes of which are not changed. That is, the encoder 170 may determine whether the sizes of the first blocks 310 and 312 are to be changed in consideration of rate-distortion costs, etc. during compressing of the image. When a process of changing the sizes of the first blocks 310 and 312 is performed by increasing part of the image having more high-frequency components, the bitstream generator 160 may generate a bitstream including block ratio information indicating information regarding the change of the sizes of the first blocks 310 and 312 and the like.

Operations of the image encoding device 150 related to FIGS. 3A and 3B may be substantially the same as or opposite to those of the image decoding device 100 related to FIGS. 3A and 3B and are thus not described in detail here.

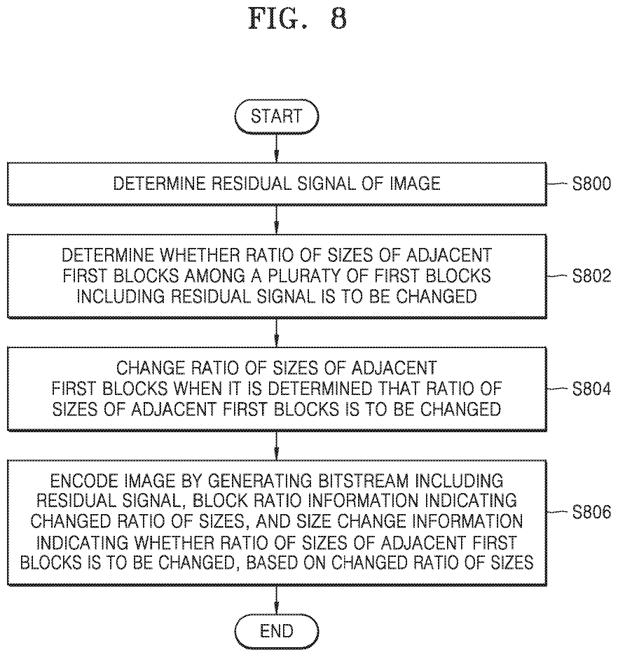

FIG. 8 is a flowchart of a method of encoding an image by determining whether a ratio of sizes of first blocks is to be changed and encoding the image by using the changed first blocks, the method being performed by the image encoding device 150, according to an embodiment. In one embodiment, the encoder 170 may determine a residual signal of the image in operation S800, and determine whether a ratio of sizes of adjacent first blocks among first blocks including the residual signal is to be changed in operation S802.

In one embodiment, when it is determined that the ratio of the sizes of the adjacent first blocks is to be changed, the encoder 170 may change a ratio to which the ratio of the sizes of the first blocks is to be changed in operation S804.

In one embodiment, the encoder 170 may encode the image based on at least one of the first blocks of which the sizes are changed in operation S806. In one embodiment, the encoder 170 may encode the image by generating a bitstream including at least one among the residual signal, block ratio information and size change information, based on at least one of the first blocks which are in the changed ratio of sizes.

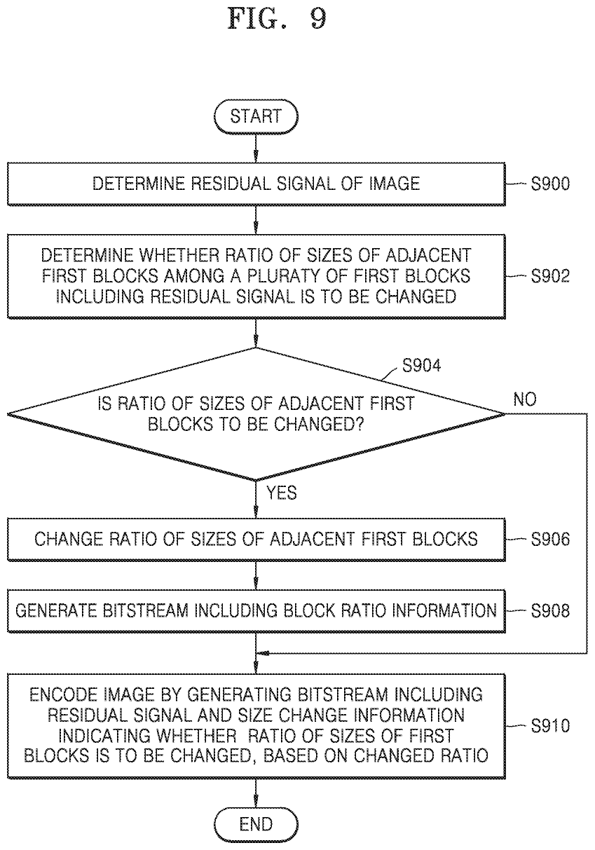

FIG. 9 is a flowchart of a process of determining whether a ratio of sizes of first blocks is to be changed and generating a bitstream including block ratio information indicating the changed ratio of the sizes of the first blocks and size change information indicating whether the ratio of the sizes of the first blocks is to be changed during encoding of an image, the process being performed by the image encoding device 150, according to an embodiment. In one embodiment, the encoder 170 may perform operations S900 and S902 of FIG. 9 in a similar way to operations S800 and S802 of FIG. 8.

In operation S904, the encoder 170 may determine whether a ratio of sizes of first blocks for splitting an image is to be changed. Whether the sizes of the first blocks are to be changed may be determined by taking into account the rate-distortion costs, etc.

In one embodiment, in operation S910, when it is determined that the ratio of the sizes of the first blocks is not to be changed, the encoder 170 may encode the image by generating a bitstream including the residual signal and size change information indicating whether the ratio of the sizes of the first blocks is to be changed, based on the ratio of the sizes of the first blocks.

In one embodiment, in operation S906, when it is determined that the ratio of the sizes of the first blocks is to be changed, the encoder 170 may change a ratio of sizes of adjacent first blocks. A ratio to which the ratio of the sizes of the first blocks is to be changed may be one of predetermined ratios. The ratio to which the ratio of the sizes of the first blocks is to be changed may be determined according to an encoding method performed in consideration of rate-distortion costs, etc. to achieve optimum efficiency.

In one embodiment, in operation S906, the encoder 170 may change the sizes of the first blocks according to the determined ratio. A process of changing sizes of first blocks has been described above with respect to various embodiments and is thus not described in detail here.

In operation S908, the bitstream generator 160 of the image encoding device 150 may generate a bitstream including block ratio information indicating the ratio of the sizes of the first blocks changed in operation S906. That is, the image encoding device 150 may determine whether the sizes of the first blocks are to be changed in operation S904, and generate a bitstream including the block ratio information in operation S908. The image encoding device 150 may determine whether the sizes of the first blocks are to be changed, and generates the bitstream including the block ratio information only in limited circumstances, thereby efficiently managing the bitstream.

In operation S910, the image encoding device 150 may encode the image by generating a bitstream including the residual signal and the size change information, based on the changed ratio of the sizes of the first blocks.

In one embodiment, the bitstream generator 160 may generate a bitstream including size change information in units of data units each including at least one first block (e.g., the second blocks used in the above-described embodiments).

In one embodiment, the bitstream generator 160 may generate a bitstream including size change information in units of second blocks each including at least one first block.

In one embodiment, it may be determined that a size of at least one first block among first blocks included in a second block is not to be changed. In this case, a process of including block ratio information regarding the at least one first block, the size of which is not to be changed into a bitstream may be skipped. The bitstream generator 160 may generate a bitstream including block ratio information in units of data units (e.g., second blocks) each including at least one first block. In another embodiment, when a size of the at least one first block included in each of the data units is not to be changed, a bitstream including block ratio information regarding the at least one first block need not be generated. That is, the image encoding device 150 may determine whether sizes of first blocks included in a second block are to be changed based on the second block, and generate a bitstream including block ratio information indicating a ratio to which a ratio of sizes of first blocks is to be changed in units of the first blocks.

In one embodiment, operations of the bitstream generator 160 and the encoder 170 described above may be performed by one encoder 170 or a processor (CPU).

In another embodiment, a first block, the size of which is to be changed by the image encoding device 150 may include residual information or an original signal of the image used before the residual information was generated. That is, a residual signal included in the first block, the size of which is changed may correspond to the difference between values of the original signal and a predicted signal, and include the original signal of the image. In the various embodiments described above, the image encoding device 150 may change an original signal included in the first block according to the process of changing sizes of first blocks, and use the changed original signal to encode the image. That is, in one embodiment, the first block may be a data unit (e.g., a coding unit) including the original signal, and the image encoding device 150 may change a size of the data unit including the original signal according to the various embodiments described above.

A method of determining data units to be used for the image decoding device 100 to decode an image according to an embodiment will be described with reference to FIGS. 10 to 23 below. An operation of the image encoding device 150 may be substantially the same as or opposite to that of the image decoding device 100 which will be described below.

FIG. 10 illustrates an operation, performed by the image decoding device 100, of determining one or more coding units by splitting a current coding unit, according to an embodiment.

According to an embodiment, the image decoding device 100 may determine a shape of a coding unit by using block shape information, and determine a splitting method of the coding unit by using split shape information. That is, a coding unit splitting method indicated by the split shape information may be determined based on a block shape indicated by the block shape information used by the image decoding device 100.

According to an embodiment, the image decoding device 100 may use the block shape information indicating that the current coding unit has a square shape. For example, the image decoding device 100 may determine whether not to split a square coding unit, whether to vertically split the square coding unit, whether to horizontally split the square coding unit, or whether to split the square coding unit into four coding units, based on the split shape information. Referring to FIG. 10, when the block shape information of a current coding unit 1000 indicates a square shape, the decoder 120 may determine that a coding unit 1010a having the same size as the current coding unit 1000 is not split, based on the split shape information indicating not to perform splitting, or may determine coding units 1010b, 1010c, or 1010d split based on the split shape information indicating a predetermined splitting method.

Referring to FIG. 10, according to an embodiment, the image decoding device 100 may determine two coding units 1010b obtained by splitting the current coding unit 1000 in a vertical direction, based on the split shape information indicating to perform splitting in a vertical direction. The image decoding device 100 may determine two coding units 1010c obtained by splitting the current coding unit 1000 in a horizontal direction, based on the split shape information indicating to perform splitting in a horizontal direction. The image decoding device 100 may determine four coding units 1010d obtained by splitting the current coding unit 1000 in vertical and horizontal directions, based on the split shape information indicating to perform splitting in vertical and horizontal directions. However, splitting methods of the square coding unit are not limited to the above-described methods, and the split shape information may indicate various methods. Predetermined splitting methods of splitting the square coding unit will be described in detail below in relation to various embodiments.

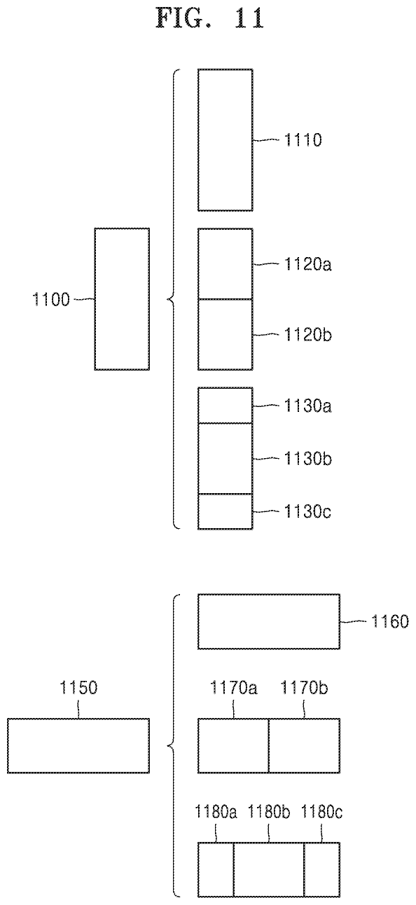

FIG. 11 illustrates an operation, performed by the image decoding device 100, of determining one or more coding units by splitting a non-square coding unit, according to an embodiment.

According to an embodiment, the image decoding device 100 may use block shape information indicating that a current coding unit has a non-square shape. The image decoding device 100 may determine whether not to split the non-square current coding unit or whether to split the non-square current coding unit by using a predetermined splitting method, based on split shape information. Referring to FIG. 11, when the block shape information of a current coding unit 1100 or 1150 indicates a non-square shape, the image decoding device 100 may determine that a coding unit 1110 or 1160 having the same size as the current coding unit 1100 or 1150 is not split, based on the split shape information indicating not to perform splitting, or determine coding units 1120a and 1120b, 1130a to 1130c, 1170a and 1170b, or 1180a to 1180c split based on the split shape information indicating a predetermined splitting method. Predetermined splitting methods of splitting a non-square coding unit will be described in detail below in relation to various embodiments.

According to an embodiment, the image decoding device 100 may determine a splitting method of a coding unit by using the split shape information and, in this case, the split shape information may indicate the number of one or more coding units generated by splitting a coding unit. Referring to FIG. 11, when the split shape information indicates to split the current coding unit 1100 or 1150 into two coding units, the image decoding device 100 may determine two coding units 1120a and 1120b, or 1170a and 1170b included in the current coding unit 1100 or 1150, by splitting the current coding unit 1100 or 1150 based on the split shape information.

According to an embodiment, when the image decoding device 100 splits the non-square current coding unit 1100 or 1150 based on the split shape information, the location of a long side of the non-square current coding unit 1100 or 1150 may be considered. For example, the image decoding device 100 may determine a plurality of coding units by dividing a long side of the current coding unit 1100 or 1150 considering the shape of the current coding unit 1100 or 1150.

According to an embodiment, when the split shape information indicates to split a coding unit into an odd number of blocks, the image decoding device 100 may determine an odd number of coding units included in the current coding unit 1100 or 1150. For example, when the split shape information indicates to split the current coding unit 1100 or 1150 into three coding units, the image decoding device 100 may split the current coding unit 1100 or 1150 into three coding units 1130a, 1130b, and 1130c, or 1180a, 1180b, and 1180c. According to an embodiment, the image decoding device 100 may determine an odd number of coding units included in the current coding unit 1100 or 1150, and not all the determined coding units have the same size. For example, a predetermined coding unit 1130b or 1180b from among the determined odd number of coding units 1130a, 1130b, and 1130c, or 1180a, 1180b, and 1180c may have a size different from the size of the other coding units 1130a and 1130c, or 1180a and 1180c. That is, coding units which may be determined by splitting the current coding unit 1100 or 1150 may have multiple sizes and, in some cases, all of the odd number of coding units 1130a, 1130b, and 1130c, or 1180a, 1180b, and 1180c may have different sizes.

According to an embodiment, when the split shape information indicates to split a coding unit into an odd number of blocks, the image decoding device 100 may determine an odd number of coding units included in the current coding unit 1100 or 1150, and put a predetermined restriction on at least one coding unit from among the odd number of coding units generated by splitting the current coding unit 1100 or 1150. Referring to FIG. 11, the image decoding device 100 may allow a decoding method of the coding unit 1130b or 1180b to be different from that of the other coding units 1130a and 1130c, or 1180a and 1180c, wherein the coding unit 1130b or 1180b is at a center location from among the three coding units 1130a, 1130b, and 1130c, or 1180a, 1180b, and 1180c generated by splitting the current coding unit 1100 or 1150. For example, the image decoding device 100 may restrict the coding unit 1130b or 1180b at the center location to be no longer split or to be split by only a predetermined number of times, unlike the other coding units 1130a and 1130c, or 1180a and 1180c.

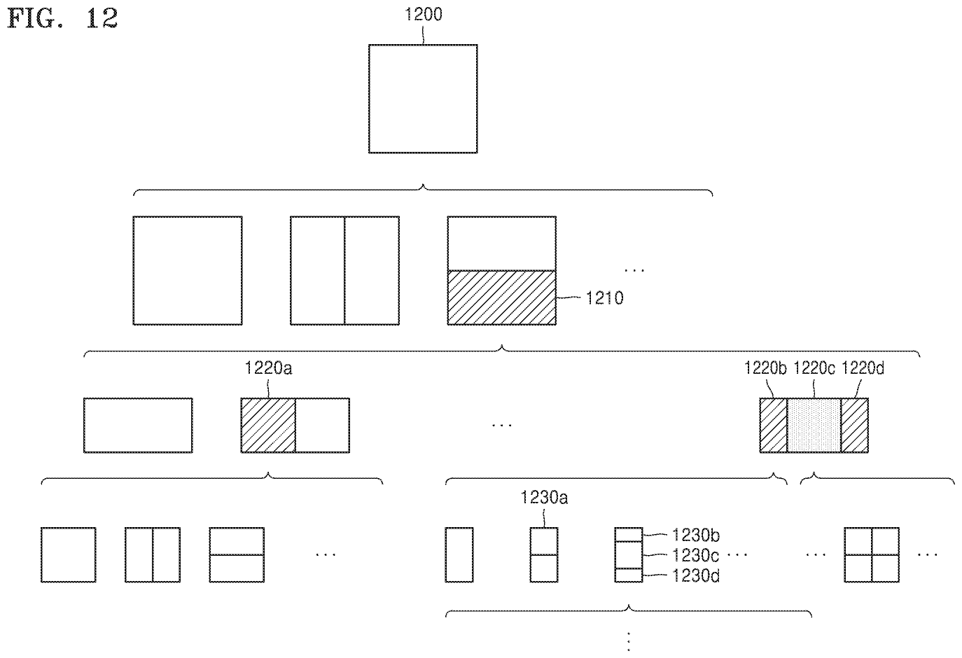

FIG. 12 illustrates an operation, performed by the image decoding device 100, of splitting a coding unit based on at least one of block shape information and split shape information, according to an embodiment.

According to an embodiment, the image decoding device 100 may determine to or not to split a square first coding unit 1200 into coding units, based on at least one of the block shape information and the split shape information. According to an embodiment, when the split shape information indicates to split the first coding unit 1200 in a horizontal direction, the image decoding device 100 may determine a second coding unit 1210 by splitting the first coding unit 1200 in a horizontal direction. A first coding unit, a second coding unit, and a third coding unit used according to an embodiment are terms used to understand a relation before and after splitting a coding unit. For example, a second coding unit may be determined by splitting a first coding unit, and a third coding unit may be determined by splitting the second coding unit. It will be understood that the structure of the first, second, and third coding units follows the above descriptions.

According to an embodiment, the image decoding device 100 may determine to or not to split the determined second coding unit 1210 into coding units, based on at least one of the block shape information and the split shape information. Referring to FIG. 12, the image decoding device 100 may or may not split the non-square second coding unit 1210, which is determined by splitting the first coding unit 1200, into one or more third coding units 1220a, or 1220b, 1220c, and 1220d based on at least one of the block shape information and the split shape information. The image decoding device 100 may obtain at least one of the block shape information and the split shape information, and determine a plurality of various-shaped second coding units (e.g., 1210) by splitting the first coding unit 1200, based on the obtained at least one of the block shape information and the split shape information, and the second coding unit 1210 may be split by using the splitting method of the first coding unit 1200, based on at least one of the block shape information and the split shape information. According to an embodiment, when the first coding unit 1200 is split into the second coding units 1210 based on at least one of the block shape information and the split shape information of the first coding unit 1200, the second coding unit 1210 may also be split into the third coding units 1220a, or 1220b, 1220c, and 1220d based on at least one of the block shape information and the split shape information of the second coding unit 1210. That is, a coding unit may be recursively split based on at least one of the block shape information and the split shape information of each coding unit. Therefore, a square coding unit may be determined by splitting a non-square coding unit, and a non-square coding unit may be determined by recursively splitting the square coding unit. Referring to FIG. 12, a predetermined coding unit from among an odd number of third coding units 1220b, 1220c, and 1220d determined by splitting the non-square second coding unit 1210 (e.g., a coding unit at a center location or a square coding unit) may be recursively split. According to an embodiment, the square third coding unit 1220c from among the odd number of third coding units 1220b, 1220c, and 1220d may be split in a horizontal direction into a plurality of fourth coding units. A non-square fourth coding unit from among the plurality of fourth coding units may be split into a plurality of coding units. For example, the non-square fourth coding unit may be split into an odd number of coding units.

A method that may be used to recursively split a coding unit will be described below in relation to various embodiments.

According to an embodiment, the image decoding device 100 may determine to split each of the third coding units 1220a, or 1220b, 1220c, and 1220d into coding units or not to split the second coding unit 1210, based on at least one of the block shape information and the split shape information. According to an embodiment, the image decoding device 100 may split the non-square second coding unit 1210 into the odd number of third coding units 1220b, 1220c, and 1220d. The image decoding device 100 may put a predetermined restriction on a predetermined third coding unit from among the odd number of third coding units 1220b, 1220c, and 1220d. For example, the image decoding device 100 may restrict the third coding unit 1220c at a center location from among the odd number of third coding units 1220b, 1220c, and 1220d to be no longer split or to be split by a settable number of times. Referring to FIG. 12, the image decoding device 100 may restrict the third coding unit 1220c, which is at the center location from among the odd number of third coding units 1220b, 1220c, and 1220d included in the non-square second coding unit 1210, to be no longer split, to be split by using a predetermined splitting method (e.g., split into only four coding units or split by using a splitting method of the second coding unit 1210), or to be split by only a predetermined number of times (e.g., split by only n times (where n>0)). However, the restrictions on the third coding unit 1220c at the center location are not limited to the above-described examples, and may include various restrictions for decoding the third coding unit 1220c at the center location differently from the other third coding units 1220b and 1220d.

According to an embodiment, the image decoding device 100 may obtain at least one of the block shape information and the split shape information, which is used to split a current coding unit, from a predetermined location in the current coding unit.

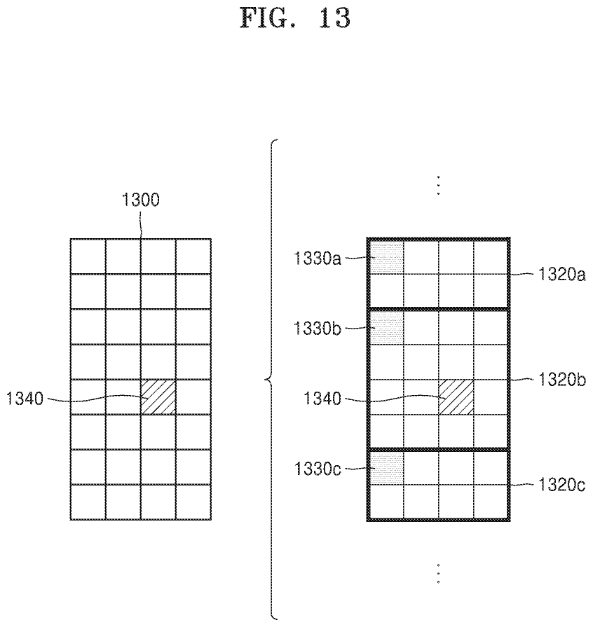

FIG. 13 illustrates a method, performed by the image decoding device 100, of determining a predetermined coding unit from among an odd number of coding units, according to an embodiment. Referring to FIG. 13, at least one of block shape information and split shape information of a current coding unit 1300 may be obtained from a sample of a predetermined location from among a plurality of samples included in the current coding unit 1300 (e.g., a sample 1340 of a center location). However, the predetermined location in the current coding unit 1300, from which at least one of the block shape information and the split shape information may be obtained, is not limited to the center location in FIG. 13, and may include various locations included in the current coding unit 1300 (e.g., top, bottom, left, right, top left, bottom left, top right, and bottom right locations). The image decoding device 100 may obtain at least one of the block shape information and the split shape information from the predetermined location and determine to or not to split the current coding unit into various-shaped and various-sized coding units.

According to an embodiment, when the current coding unit is split into a predetermined number of coding units, the image decoding device 100 may select one of the coding units. Various methods may be used to select one of a plurality of coding units, as will be described below in relation to various embodiments.

According to an embodiment, the image decoding device 100 may split the current coding unit into a plurality of coding units, and determine a coding unit at a predetermined location.

FIG. 13 illustrates a method, performed by the image decoding device 100, of determining a coding unit of a predetermined location from among an odd number of coding units, according to an embodiment.

According to an embodiment, the image decoding device 100 may use information indicating locations of the odd number of coding units, to determine a coding unit at a center location from among the odd number of coding units. Referring to FIG. 13, the image decoding device 100 may determine an odd number of coding units 1320a, 1320b, and 1320c by splitting the current coding unit 1300. The image decoding device 100 may determine a coding unit 1320b at a center location by using information about locations of the odd number of coding units 1320a to 1320c. For example, the image decoding device 100 may determine the coding unit 1320b of the center location by determining the locations of the coding units 1320a, 1320b, and 1320c based on information indicating locations of predetermined samples included in the coding units 1320a, 1320b, and 1320c. In more detail, the image decoding device 100 may determine the coding unit 1320b at the center location by determining the locations of the coding units 1320a, 1320b, and 1320c based on information indicating locations of top left samples 1330a, 1330b, and 1330c of the coding units 1320a, 1320b, and 1320c.

According to an embodiment, the information indicating the locations of the top left samples 1330a, 1330b, and 1330c, which are included in the coding units 1320a, 1320b, and 1320c, respectively, may include information about locations or coordinates of the coding units 1320a, 1320b, and 1320c in a picture. According to an embodiment, the information indicating the locations of the top left samples 1330a, 1330b, and 1330c, which are included in the coding units 1320a, 1320b, and 1320c, respectively, may include information indicating widths or heights of the coding units 1320a, 1320b, and 1320c included in the current coding unit 1300, and the widths or heights may correspond to information indicating differences between the coordinates of the coding units 1320a, 1320b, and 1320c in the picture. That is, the image decoding device 100 may determine the coding unit 1320b at the center location by directly using the information about the locations or coordinates of the coding units 1320a, 1320b, and 1320c in the picture, or by using the information about the widths or heights of the coding units, which correspond to the difference values between the coordinates.

According to an embodiment, information indicating the location of the top left sample 1330a of the upper coding unit 1320a may include a coordinate (xa, ya), information indicating the location of the top left sample 1330b of the middle coding unit 1320b may include a coordinate (xb, yb), and information indicating the location of the top left sample 1330c of the lower coding unit 1320c may include a coordinate (xc, yc). The image decoding device 100 may determine the middle coding unit 1320b by using the coordinates of the top left samples 1330a, 1330b, and 1330c which are included in the coding units 1320a, 1320b, and 1320c, respectively. For example, when the coordinates of the top left samples 1330a, 1330b, and 1330c are sorted in an ascending or descending order, the coding unit 1320b including the coordinate (xb, yb) of the sample 1330b at a center location may be determined as a coding unit at a center location from among the coding units 1320a, 1320b, and 1320c determined by splitting the current coding unit 1300. However, the coordinates indicating the locations of the top left samples 1330a, 1330b, and 1330c may include coordinates indicating absolute locations in the picture, or may use a coordinate (dxb, dyb) indicating a relative location of the top left sample 1330b of the middle coding unit 1320b and a coordinate (dxc, dyc) indicating a relative location of the top left sample 1330c of the lower coding unit 1320c with reference to the location of the top left sample 1330a of the upper coding unit 1320a. A method of determining a coding unit at a predetermined location by using a coordinate of a sample included in the coding unit, as information indicating a location of the sample, is not limited to the above-described method, and may include various arithmetic methods capable of using the coordinate of the sample.

According to an embodiment, the image decoding device 100 may split the current coding unit 1300 into a plurality of coding units 1320a, 1320b, and 1320c, and select one of the coding units 1320a, 1320b, and 1320c based on a predetermined criterion. For example, the image decoding device 100 may select the coding unit 1320b, which has a size different from that of the others, from among the coding units 1320a, 1320b, and 1320c.

According to an embodiment, the image decoding device 100 may determine the widths or heights of the coding units 1320a, 1320b, and 1320c by using the coordinate (xa, ya) indicating the location of the top left sample 1330a of the upper coding unit 1320a, the coordinate (xb, yb) indicating the location of the top left sample 1330b of the middle coding unit 1320b, and the coordinate (xc, yc) indicating the location of the top left sample 1330c of the lower coding unit 1320c. The image decoding device 100 may determine the sizes of the coding units 1320a, 1320b, and 1320c by using the coordinates (xa, ya), (xb, yb), and (xc, yc) indicating the locations of the coding units 1320a, 1320b, and 1320c.

According to an embodiment, the image decoding device 100 may determine the width of the upper coding unit 1320a to be xb-xa and determine the height thereof to be yb-ya. According to an embodiment, the image decoding device 100 may determine the width of the middle coding unit 1320b to be xc-xb and determine the height thereof to be yc-yb. According to an embodiment, the image decoding device 100 may determine the width or height of the lower coding unit 1320c by using the width or height of the current coding unit 1300 or the widths or heights of the upper and middle coding units 1320a and 1320b. The image decoding device 100 may determine a coding unit, which has a size different from that of the others, based on the determined widths and heights of the coding units 1320a to 1320c. Referring to FIG. 13, the image decoding device 100 may determine the middle coding unit 1320b, which has a size different from the size of the upper and lower coding units 1320a and 1320c, as the coding unit of the predetermined location. However, the above-described method, performed by the image decoding device 100, of determining a coding unit having a size different from the size of the other coding units merely corresponds to an example of determining a coding unit at a predetermined location by using the sizes of coding units, which are determined based on coordinates of samples, and thus various methods of determining a coding unit at a predetermined location by comparing the sizes of coding units, which are determined based on coordinates of predetermined samples, may be used.

However, locations of samples considered to determine locations of coding units are not limited to the above-described top left locations, and information about arbitrary locations of samples included in the coding units may be used.

According to an embodiment, the image decoding device 100 may select a coding unit at a predetermined location from among an odd number of coding units determined by splitting the current coding unit, considering the shape of the current coding unit. For example, when the current coding unit has a non-square shape, a width of which is longer than a height, the image decoding device 100 may determine the coding unit at the predetermined location in a horizontal direction. That is, the image decoding device 100 may determine one of coding units at different locations in a horizontal direction and put a restriction on the coding unit. When the current coding unit has a non-square shape, a height of which is longer than a width, the image decoding device 100 may determine the coding unit at the predetermined location in a vertical direction. That is, the image decoding device 100 may determine one of coding units at different locations in a vertical direction and put a restriction on the coding unit.

According to an embodiment, the image decoding device 100 may use information indicating locations of an even number of coding units, to determine the coding unit at the predetermined location from among the even number of coding units. The image decoding device 100 may determine an even number of coding units by splitting the current coding unit, and determine the coding unit at the predetermined location by using the information about the locations of the even number of coding units. An operation related thereto may correspond to the operation of determining a coding unit at a predetermined location (e.g., a center location) from among an odd number of coding units, which has been described in detail above in relation to FIG. 13, and thus detailed descriptions thereof will not be provided herein.

According to an embodiment, when a non-square current coding unit is split into a plurality of coding units, predetermined information about a coding unit at a predetermined location may be used in a splitting operation to determine the coding unit at the predetermined location from among the plurality of coding units. For example, the image decoding device 100 may use at least one of block shape information and split shape information, which is stored in a sample included in a coding unit at a center location, in a splitting operation to determine the coding unit at the center location from among the plurality of coding units determined by splitting the current coding unit.

Referring to FIG. 13, the image decoding device 100 may split the current coding unit 1300 into a plurality of coding units 1320a, 1320b, and 1320c based on at least one of the block shape information and the split shape information, and determine a coding unit 1320b at a center location from among the plurality of the coding units 1320a, 1320b, and 1320c. Furthermore, the image decoding device 100 may determine the coding unit 1320b at the center location, in consideration of a location from which at least one of the block shape information and the split shape information is obtained. That is, at least one of the block shape information and the split shape information of the current coding unit 1300 may be obtained from the sample 1340 at a center location of the current coding unit 1300 and, when the current coding unit 1300 is split into the plurality of coding units 1320a, 1320b, and 1320c based on at least one of the block shape information and the split shape information, the coding unit 1320b including the sample 1340 may be determined as the coding unit at the center location. However, information used to determine the coding unit at the center location is not limited to at least one of the block shape information and the split shape information, and various types of information may be used to determine the coding unit at the center location.

According to an embodiment, predetermined information for identifying the coding unit at the predetermined location may be obtained from a predetermined sample included in a coding unit to be determined. Referring to FIG. 13, the image decoding device 100 may use at least one of the block shape information and the split shape information, which is obtained from a sample at a predetermined location in the current coding unit 1300 (e.g., a sample at a center location of the current coding unit 1300) to determine a coding unit at a predetermined location from among the plurality of the coding units 1320a, 1320b, and 1320c determined by splitting the current coding unit 1300 (e.g., a coding unit at a center location from among a plurality of split coding units). That is, the image decoding device 100 may determine the sample at the predetermined location by considering a block shape of the current coding unit 1300, determine the coding unit 1320b including a sample, from which predetermined information (e.g., at least one of the block shape information and the split shape information) may be obtained, from among the plurality of coding units 1320a, 1320b, and 1320c determined by splitting the current coding unit 1300, and put a predetermined restriction on the coding unit 1320b. Referring to FIG. 13, according to an embodiment, the image decoding device 100 may determine the sample 1340 at the center location of the current coding unit 1300 as the sample from which the predetermined information may be obtained, and put a predetermined restriction on the coding unit 1320b including the sample 1340, in a decoding operation. However, the location of the sample from which the predetermined information may be obtained is not limited to the above-described location, and may include arbitrary locations of samples included in the coding unit 1320b to be determined for a restriction.

According to an embodiment, the location of the sample from which the predetermined information may be obtained may be determined based on the shape of the current coding unit 1300. According to an embodiment, the block shape information may indicate whether the current coding unit has a square or non-square shape, and the location of the sample from which the predetermined information may be obtained may be determined based on the shape. For example, the image decoding device 100 may determine a sample located on a boundary for dividing at least one of a width and height of the current coding unit in half, as the sample from which the predetermined information may be obtained, by using at least one of information about the width of the current coding unit and information about the height of the current coding unit. As another example, when the block shape information of the current coding unit indicates a non-square shape, the image decoding device 100 may determine one of samples adjacent to a boundary for dividing a long side of the current coding unit in half, as the sample from which the predetermined information may be obtained.

According to an embodiment, when the current coding unit is split into a plurality of coding units, the image decoding device 100 may use at least one of the block shape information and the split shape information to determine a coding unit at a predetermined location from among the plurality of coding units. According to an embodiment, the image decoding device 100 may obtain at least one of the block shape information and the split shape information from a sample at a predetermined location in a coding unit, and split the plurality of coding units, which are generated by splitting the current coding unit, by using at least one of the split shape information and the block shape information, which is obtained from the sample of the predetermined location in each of the plurality of coding units. That is, a coding unit may be recursively split based on at least one of the block shape information and the split shape information, which is obtained from the sample of the predetermined location in each coding unit. An operation of recursively splitting a coding unit has been described above in relation to FIG. 12, and thus detailed descriptions thereof will not be provided herein.

According to an embodiment, the image decoding device 100 may determine one or more coding units by splitting the current coding unit, and determine an order of decoding the one or more coding units, based on a predetermined block (e.g., the current coding unit).

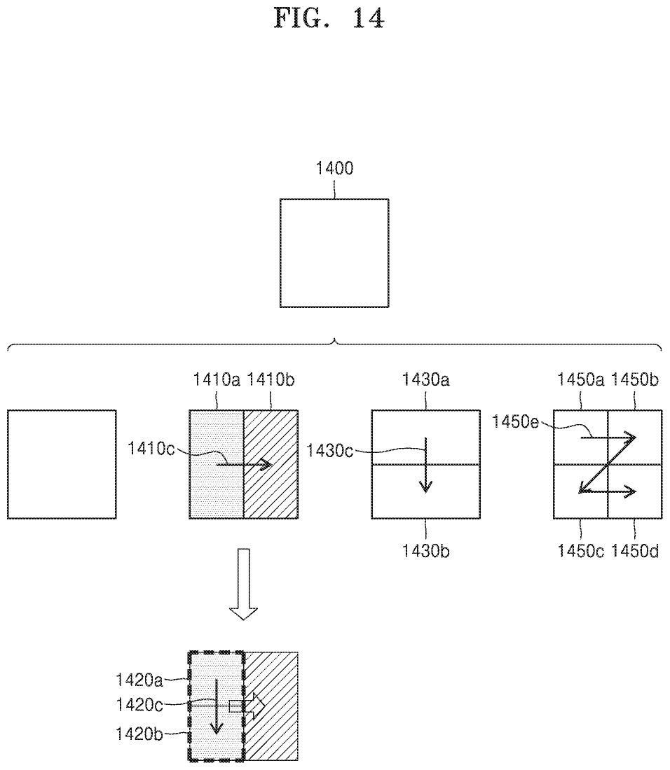

FIG. 14 illustrates a processing order of a plurality of coding units when the image decoding device 100 determines the plurality of coding units by splitting a current coding unit, according to an embodiment.

According to an embodiment, the image decoding device 100 may determine second coding units 1410a and 1410b by splitting a first coding unit 1400 in a vertical direction, determine second coding units 1430a and 1430b by splitting the first coding unit 1400 in a horizontal direction, or determine second coding units 1450a to 1450d by splitting the first coding unit 1400 in vertical and horizontal directions, based on block shape information and split shape information.

Referring to FIG. 14, the image decoding device 100 may determine to process the second coding units 1410a and 1410b, which are determined by splitting the first coding unit 1400 in a vertical direction, in a horizontal direction order 1410c. The image decoding device 100 may determine to process the second coding units 1430a and 1430b, which are determined by splitting the first coding unit 1400 in a horizontal direction, in a vertical direction order 1430c. The image decoding device 100 may determine to process the second coding units 1450a to 1450d, which are determined by splitting the first coding unit 1400 in vertical and horizontal directions, in a predetermined order for processing coding units in a row and then processing coding units in a next row (e.g., in a raster scan order or Z-scan order 1450e).

According to an embodiment, the image decoding device 100 may recursively split coding units. Referring to FIG. 14, the image decoding device 100 may determine a plurality of coding units 1410a, 1410b, 1430a, 1430b, 1450a, 1450b, 1450c, and 1450d by splitting the first coding unit 1400, and recursively split each of the determined plurality of coding units 1410a, 1410b, 1430a, 1430b, 1450a, 1450b, 1450c, and 1450d. A splitting method of the plurality of coding units 1410a, 1410b, 1430a, 1430b, 1450a, 1450b, 1450c, and 1450d may correspond to a splitting method of the first coding unit 1400. As such, each of the plurality of coding units 1410a, 1410b, 1430a, 1430b, 1450a, 1450b, 1450c, and 1450d may be independently split into a plurality of coding units. Referring to FIG. 14, the image decoding device 100 may determine the second coding units 1410a and 1410b by splitting the first coding unit 1400 in a vertical direction, and determine to independently split or not to split each of the second coding units 1410a and 1410b.

According to an embodiment, the image decoding device 100 may determine third coding units 1420a and 1420b by splitting the left second coding unit 1410a in a horizontal direction, and may not split the right second coding unit 1410b.

According to an embodiment, a processing order of coding units may be determined based on an operation of splitting a coding unit. In other words, a processing order of split coding units may be determined based on a processing order of coding units immediately before being split. The image decoding device 100 may determine a processing order of the third coding units 1420a and 1420b determined by splitting the left second coding unit 1410a, independently of the right second coding unit 1410b. Since the third coding units 1420a and 1420b are determined by splitting the left second coding unit 1410a in a horizontal direction, the third coding units 1420a and 1420b may be processed in a vertical direction order 1420c. Since the left and right second coding units 1410a and 1410b are processed in the horizontal direction order 1410c, the right second coding unit 1410b may be processed after the third coding units 1420a and 1420b included in the left second coding unit 1410a are processed in the vertical direction order 1420c. An operation of determining a processing order of coding units based on a coding unit before being split is not limited to the above-described example, and various methods may be used to independently process coding units, which are split and determined to various shapes, in a predetermined order.

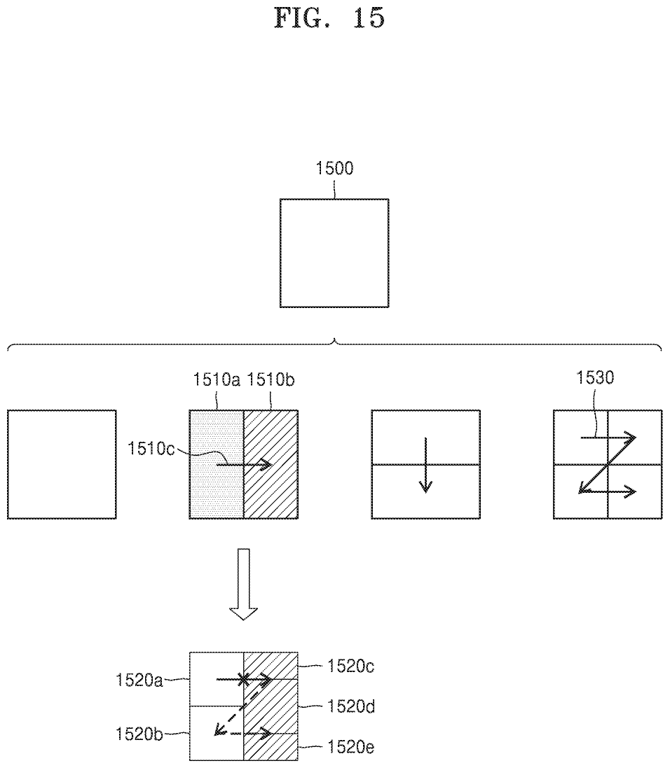

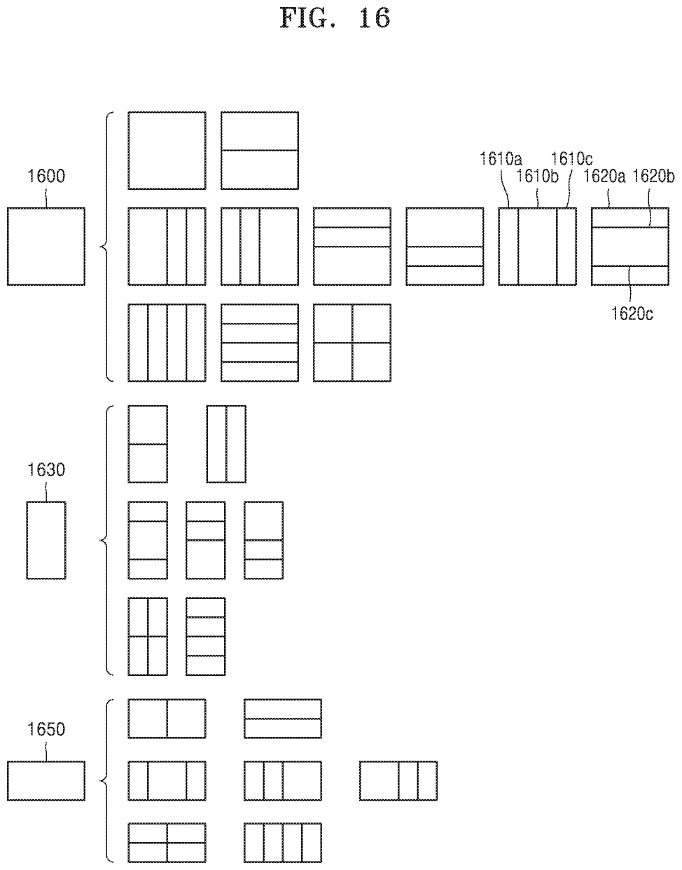

FIG. 15 illustrates an operation, performed by the image decoding device 100, of determining that a current coding unit is split into an odd number of coding units, when the coding units are not processable in a predetermined order, according to an embodiment.

According to an embodiment, the image decoding device 100 may determine whether the current coding unit is split into an odd number of coding units, based on obtained block shape information and split shape information. Referring to FIG. 15, a square first coding unit 1500 may be split into non-square second coding units 1510a and 1510b, and the second coding units 1510a and 1510b may be independently split into third coding units 1520a and 1520b, and 1520c to 1520e. According to an embodiment, the image decoding device 100 may determine a plurality of third coding units 1520a and 1520b by splitting the left second coding unit 1510a in a horizontal direction, and split the right second coding unit 1510b into an odd number of third coding units 1520c to 1520e.

According to an embodiment, the image decoding device 100 may determine whether any coding unit is split into an odd number of coding units, by deciding whether the third coding units 1520a and 1520b, and 1520c to 1520e are processable in a predetermined order. Referring to FIG. 15, the image decoding device 100 may determine the third coding units 1520a and 1520b, and 1520c to 1520e by recursively splitting the first coding unit 1500. The image decoding device 100 may determine whether any of the first coding unit 1500, the second coding units 1510a and 1510b, and the third coding units 1520a and 1520b, and 1520c to 1520e is split into an odd number of coding units, based on at least one of the block shape information and the split shape information. For example, the right second coding unit 1510b may be split into an odd number of third coding units 1520c to 1520e. A processing order of a plurality of coding units included in the first coding unit 1500 may be a predetermined order (e.g., a Z-scan order 1530), and the image decoding device 100 may decide whether the third coding units 1520c to 1520e, which are determined by splitting the right second coding unit 1510b into an odd number of coding units, satisfy a condition for processing in the predetermined order.

According to an embodiment, the image decoding device 100 may determine whether the third coding units 1520a and 1520b, and 1520c to 1520e included in the first coding unit 1500 satisfy the condition for processing in the predetermined order, and the condition relates to whether at least one of a width and height of the second coding units 1510a and 1510b is divided in half along a boundary of the third coding units 1520a and 1520b, and 1520c to 1520e. For example, the third coding units 1520a and 1520b determined by dividing the height of the non-square left second coding unit 1510a in half satisfy the condition. However, since boundaries of the third coding units 1520c to 1520e determined by splitting the right second coding unit 1510b into three coding units do not divide the width or height of the right second coding unit 1510b in half, it may be determined that the third coding units 1520c to 1520e do not satisfy the condition. When the condition is not satisfied as described above, the image decoding device 100 may decide disconnection of a scan order, and determine that the right second coding unit 1510b is split into an odd number of coding units, based on the result of decision. According to an embodiment, when a coding unit is split into an odd number of coding units, the image decoding device 100 may put a predetermined restriction on a coding unit of a predetermined location among the split coding units. The restriction or the predetermined location has been described above in relation to various embodiments, and thus a detailed description thereof will not be provided herein.

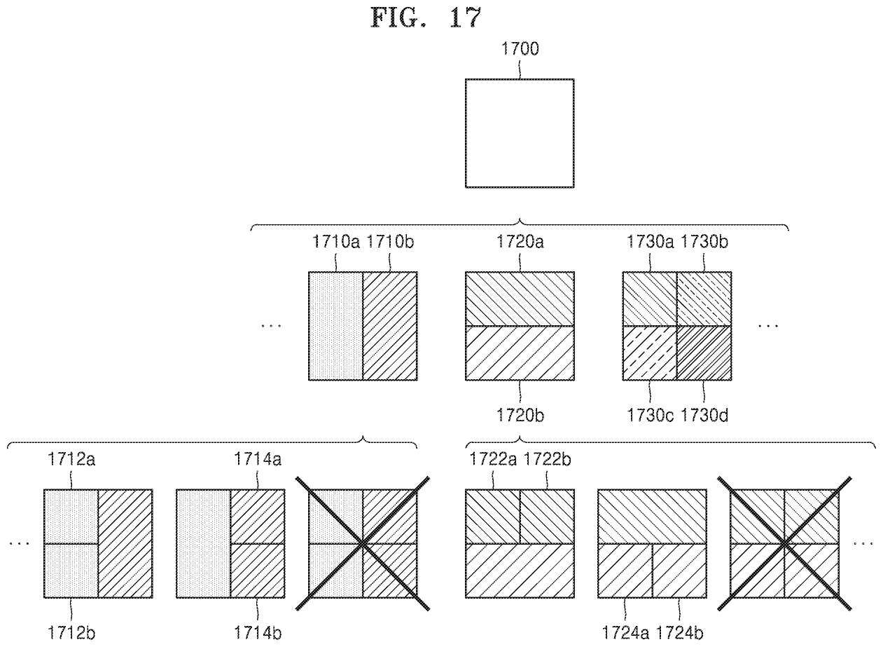

FIG. 16 illustrates an operation, performed by the image decoding device 100, of determining one or more coding units by splitting a first coding unit 1600, according to an embodiment. According to an embodiment, the image decoding device 100 may split the first coding unit 1600, based on at least one of block shape information and split shape information, which is obtained by a receiver. The square first coding unit 1600 may be split into four square coding units or into a plurality of non-square coding units. For example, referring to FIG. 16, when the block shape information indicates that the first coding unit 1600 has a square shape and the split shape information indicates to split the first coding unit 1600 into non-square coding units, the image decoding device 100 may split the first coding unit 1600 into a plurality of non-square coding units. In more detail, when the split shape information indicates to determine an odd number of coding units by splitting the first coding unit 1600 in a horizontal direction or a vertical direction, the image decoding device 100 may split the square first coding unit 1600 into an odd number of coding units, e.g., second coding units 1610a, 1610b, and 1610c determined by splitting the square first coding unit 1600 in a vertical direction or second coding units 1620a, 1620b, and 1620c determined by splitting the square first coding unit 1600 in a horizontal direction.

According to an embodiment, the image decoding device 100 may determine whether the second coding units 1610a, 1610b, 1610c, 1620a, 1620b, and 1620c included in the first coding unit 1600 satisfy a condition for processing in a predetermined order, and the condition relates to whether at least one of a width and height of the first coding unit 1600 is divided in half along a boundary of the second coding units 1610a, 1610b, 1610c, 1620a, 1620b, and 1620c. Referring to FIG. 16, since boundaries of the second coding units 1610a, 1610b, and 1610c determined by splitting the square first coding unit 1600 in a vertical direction do not divide the width of the first coding unit 1600 in half, it may be determined that the first coding unit 1600 does not satisfy the condition for processing in the predetermined order. In addition, since boundaries of the second coding units 1620a, 1620b, and 1620c determined by splitting the square first coding unit 1600 in a horizontal direction do not divide the height of the first coding unit 1600 in half, it may be determined that the first coding unit 1600 does not satisfy the condition for processing in the predetermined order. When the condition is not satisfied as described above, the image decoding device 100 may decide disconnection of a scan order, and determine that the first coding unit 1600 is split into an odd number of coding units, based on the result of decision. According to an embodiment, when a coding unit is split into an odd number of coding units, the image decoding device 100 may put a predetermined restriction on a coding unit at a predetermined location from among the split coding units. The restriction or the predetermined location has been described above in relation to various embodiments, and thus detailed descriptions thereof will not be provided herein.

According to an embodiment, the image decoding device 100 may determine various-shaped coding units by splitting a first coding unit.

Referring to FIG. 16, the image decoding device 100 may split the square first coding unit 1600 or a non-square first coding unit 1630 or 1650 into various-shaped coding units.

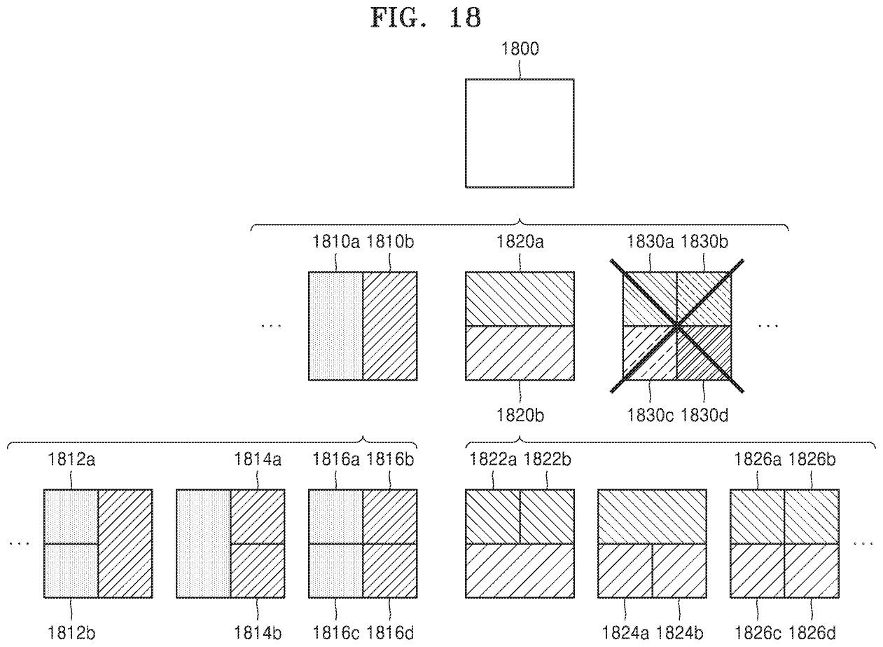

FIG. 17 illustrates that a shape into which a second coding unit is splittable by the image decoding device 100 is restricted when the second coding unit having a non-square shape, which is determined by splitting a first coding unit 1700, satisfies a predetermined condition, according to an embodiment.

According to an embodiment, the image decoding device 100 may determine to split the square first coding unit 1700 into non-square second coding units 1710a, 1710b, 1720a, and 1720b, based on at least one of block shape information and split shape information, which is obtained by the receiver. The second coding units 1710a, 1710b, 1720a, and 1720b may be independently split. As such, the image decoding device 100 may determine to or not to split the first coding unit 1700 into a plurality of coding units, based on at least one of the block shape information and the split shape information of each of the second coding units 1710a, 1710b, 1720a, and 1720b. According to an embodiment, the image decoding device 100 may determine third coding units 1712a and 1712b by splitting the non-square left second coding unit 1710a, which is determined by splitting the first coding unit 1700 in a vertical direction, in a horizontal direction. However, when the left second coding unit 1710a is split in a horizontal direction, the image decoding device 100 may restrict the right second coding unit 1710b not to be split in a horizontal direction in which the left second coding unit 1710a is split. When third coding units 1714a and 1714b are determined by also splitting the right second coding unit 1710b in a horizontal direction, since the left and right second coding units 1710a and 1710b are independently split in a horizontal direction, the third coding units 1712a, 1712b, 1714a, and 1714b may be determined. However, this case serves equally as a case in which the image decoding device 100 splits the first coding unit 1700 into four square second coding units 1730a, 1730b, 1730c, and 1730d, based on at least one of the block shape information and the split shape information, and may be inefficient in terms of image decoding.

According to an embodiment, the image decoding device 100 may determine third coding units 1722a, 1722b, 1724a, and 1724b by splitting the non-square second coding unit 1720a or 1720b, which is determined by splitting the first coding unit 1700 in a horizontal direction, in a vertical direction. However, when a second coding unit (e.g., the upper second coding unit 1720a) is split in a vertical direction, due to the above-described reason, the image decoding device 100 may restrict the other second coding unit (e.g., the lower second coding unit 1720b) not to be split in a vertical direction in which the upper second coding unit 1720a is split.

FIG. 18 illustrates an operation, performed by the image decoding device 100, of splitting a square coding unit when split shape information indicates not to split the square coding unit into four square coding units, according to an embodiment.

According to an embodiment, the image decoding device 100 may determine second coding units 1810a, 1810b, 1820a, 1820b, etc. by splitting a first coding unit 1800, based on at least one of block shape information and split shape information. The split shape information may include information about various methods of splitting a coding unit but, the information about various splitting methods may not include information for splitting a coding unit into four square coding units. According to this split shape information, the image decoding device 100 may not split the first square coding unit 1800 into four square second coding units 1830a, 1830b, 1830c, and 1830d. The image decoding device 100 may determine the non-square second coding units 1810a, 1810b, 1820a, 1820b, etc., based on the split shape information.

According to an embodiment, the image decoding device 100 may independently split the non-square second coding units 1810a, 1810b, 1820a, 1820b, etc. Each of the second coding units 1810a, 1810b, 1820a, 1820b, etc. may be recursively split in a predetermined order, and this may correspond to a splitting method of the first coding unit 1800, based on at least one of the block shape information and the split shape information.

For example, the image decoding device 100 may determine square third coding units 1812a and 1812b by splitting the left second coding unit 1810a in a horizontal direction, and determine square third coding units 1814a and 1814b by splitting the right second coding unit 1810b in a horizontal direction. Furthermore, the image decoding device 100 may determine square third coding units 1816a to 1816d by splitting both of the left and right second coding units 1810a and 1810b in a horizontal direction. In this case, coding units having the same shape as the four square second coding units 1830a, 1830b, 1830c, and 1830d split from the first coding unit 1800 may be determined.

As another example, the image decoding device 100 may determine square third coding units 1822a and 1822b by splitting the upper second coding unit 1820a in a vertical direction, and determine square third coding units 1824a and 1824b by splitting the lower second coding unit 1820b in a vertical direction. Furthermore, the image decoding device 100 may determine square third coding units 1826a, 1826b, 1826c, and 1826d by splitting both of the upper and lower second coding units 1820a and 1820b in a vertical direction. In this case, coding units having the same shape as the four square second coding units 1830a, 1830b, 1830c, and 1830d split from the first coding unit 1800 may be determined.

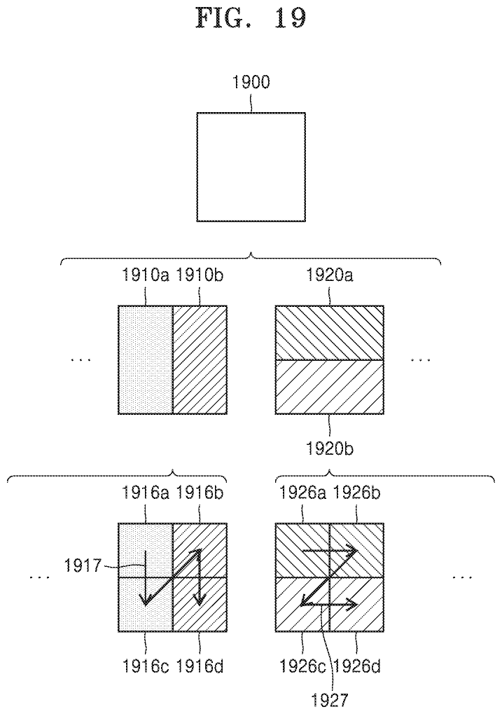

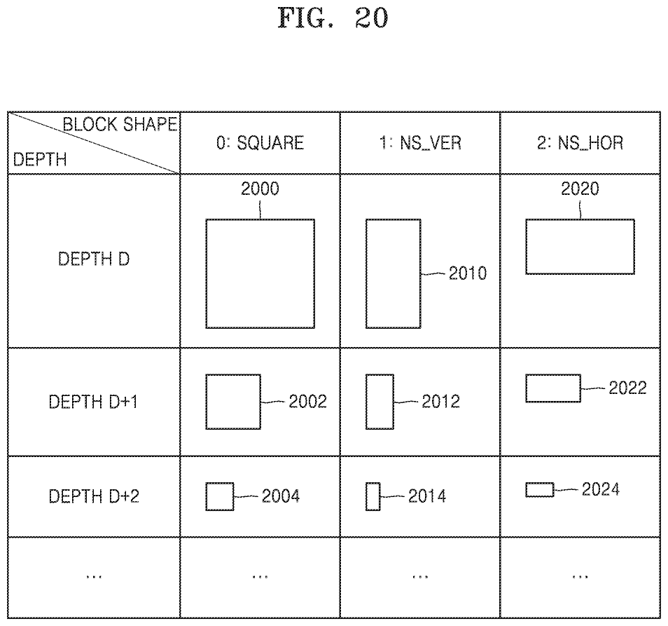

FIG. 19 illustrates that a processing order of a plurality of coding units is variable depending on an operation of splitting a coding unit, according to an embodiment.

According to an embodiment, the image decoding device 100 may split a first coding unit 1900, based on block shape information and split shape information. When the block shape information indicates a square shape and the split shape information indicates to split the first coding unit 1900 in at least one of horizontal and vertical directions, the image decoding device 100 may determine second coding units 1910a, 1910b, 1920a, and 1920b by splitting the first coding unit 1900. Referring to FIG. 19, the non-square second coding units 1910a, 1910b, 1920a, and 1920b determined by splitting the first coding unit 1900 in only a horizontal direction or vertical direction may be independently split based on the block shape information and the split shape information of each coding unit. For example, the image decoding device 100 may determine third coding units 1916a, 1916b, 1916c, and 1916d by splitting the second coding units 1910a and 1910b, which are generated by splitting the first coding unit 1900 in a vertical direction, in a horizontal direction, and determine third coding units 1926a, 1926b, 1926c, and 1926d by splitting the second coding units 1920a and 1920b, which are generated by splitting the first coding unit 1900 in a horizontal direction, in a vertical direction. An operation of splitting the second coding units 1910a, 1910b, 1920a, and 1920b has been described above in relation to FIG. 17, and thus detailed descriptions thereof will not be provided herein.

According to an embodiment, the image decoding device 100 may process coding units in a predetermined order. An operation of processing coding units in a predetermined order has been described above in relation to FIG. 14, and thus detailed descriptions thereof will not be provided herein. Referring to FIG. 19, the image decoding device 100 may determine the four square third coding units 1916a, 1916b, 1916c, 1916d, 1926a, 1926b, 1926c, and 1926d by splitting the square first coding unit 1900. According to an embodiment, the image decoding device 100 may determine a processing order of the third coding units 1916a, 1916b, 1916c, 1916d, 1926a, 1926b, 1926c, and 1926d based on a splitting method of the first coding unit 1900.

According to an embodiment, the image decoding device 100 may determine the third coding units 1916a, 1916b, 1916c, and 1916d by splitting the second coding units 1910a and 1910b generated by splitting the first coding unit 1900 in a vertical direction, in a horizontal direction, and process the third coding units 1916a, 1916b, 1916c, and 1916d in a processing order 1917 for initially processing the third coding units 1916a and 1916c, which are included in the left second coding unit 1910a, in a vertical direction and then processing the third coding unit 1916b and 1916d, which are included in the right second coding unit 1910b, in a vertical direction.

According to an embodiment, the image decoding device 100 may determine the third coding units 1926a, 1926b, 1926c, and 1926d by splitting the second coding units 1920a and 1920b generated by splitting the first coding unit 1900 in a horizontal direction, in a vertical direction, and process the third coding units 1926a, 1926b, 1926c, and 1926d in a processing order 1927 for initially processing the third coding units 1926a and 1926b, which are included in the upper second coding unit 1920a, in a horizontal direction and then processing the third coding unit 1926c and 1926d, which are included in the lower second coding unit 1920b, in a horizontal direction.

Referring to FIG. 19, the square third coding units 1916a, 1916b, 1916c, 1916d, 1926a, 1926b, 1926c, and 1926d may be determined by splitting the second coding units 1910a, 1910b, 1920a, and 1920b. Although the second coding units 1910a and 1910b are determined by splitting the first coding unit 1900 in a vertical direction differently from the second coding units 1920a and 1920b which are determined by splitting the first coding unit 1900 in a horizontal direction, the third coding units 1916a, 1916b, 1916c, 1916d, 1926a, 1926b, 1926c, and 1926d split therefrom eventually show same-shaped coding units split from the first coding unit 1900. As such, by recursively splitting a coding unit in different manners based on at least one of the block shape information and the split shape information, the image decoding device 100 may process a plurality of coding units in different orders even when the coding units are eventually determined to the same shape.

FIG. 20 illustrates an operation of determining a depth of a coding unit as the shape and size of the coding unit varies when a plurality of coding units are determined by recursively splitting the coding unit, according to an embodiment.

According to an embodiment, the image decoding device 100 may determine the depth of the coding unit based on a predetermined criterion. For example, the predetermined criterion may be the length of a long side of the coding unit. When the length of a long side of a coding unit before being split is 2n times (n>0) the length of a long side of a split current coding unit, the image decoding device 100 may determine that a depth of the current coding unit is increased from a depth of the coding unit before being split, by n. In the following description, a coding unit having an increased depth is expressed as a coding unit of a deeper depth.

Referring to FIG. 20, according to an embodiment, the image decoding device 100 may determine a second coding unit 2002 and a third coding unit 2004 of deeper depths by splitting a square first coding unit 2000 based on block shape information indicating a square shape (for example, the block shape information may be expressed as ‘0: SQUARE’). Assuming that the size of the square first coding unit 2000 is 2N×2N, the second coding unit 2002 determined by reducing a width and height of the first coding unit 2000 to ½ may have a size of N×N. Furthermore, the third coding unit 2004 determined by reducing a width and height of the second coding unit 2002 to ½ may have a size of N/2×N/2. In this case, a width and height of the third coding unit 2004 are ½\hat{ }2 times those of the first coding unit 2000. When a depth of the first coding unit 2000 is D, a depth of the second coding unit 2002, the width and height of which are ½ times those of the first coding unit 2000, may be D+1, and a depth of the third coding unit 2004, the width and height of which are ½\hat{ }2 times those of the first coding unit 2000, may be D+2.

According to an embodiment, the image decoding device 100 may determine a second coding unit 2012 or 2022 and a third coding unit 2014 or 2024 of deeper depths by splitting a non-square first coding unit 2010 or 2020 based on block shape information indicating a non-square shape (for example, the block shape information may be expressed as ‘1: NS_VER’ indicating a non-square shape, a height of which is longer than a width, or as ‘2: NS_HOR’ indicating a non-square shape, a width of which is longer than a height).

The image decoding device 100 may determine a second coding unit 2002, 2012, or 2022 by dividing at least one of a width and height of the first coding unit 2010 having a size of N×2N. That is, the image decoding device 100 may determine the second coding unit 2002 having a size of N×N or the second coding unit 2022 having a size of N×N/2 by splitting the first coding unit 2010 in a horizontal direction, or determine the second coding unit 2012 having a size of N/2×N by splitting the first coding unit 2010 in horizontal and vertical directions.

According to an embodiment, the image decoding device 100 may determine the second coding unit 2002, 2012, or 2022 by dividing at least one of a width and height of the first coding unit 2020 having a size of 2N×N. That is, the image decoding device 100 may determine the second coding unit 2002 having a size of N×N or the second coding unit 2012 having a size of N/2×N by splitting the first coding unit 2020 in a vertical direction, or determine the second coding unit 2022 having a size of N×N/2 by splitting the first coding unit 2020 in horizontal and vertical directions.

According to an embodiment, the image decoding device 100 may determine a third coding unit 2004, 2014, or 2024 by dividing at least one of a width and height of the second coding unit 2002 having a size of N×N. That is, the image decoding device 100 may determine the third coding unit 2004 having a size of N/2×N/2, the third coding unit 2014 having a size of N/2\hat{ }2×N/2, or the third coding unit 2024 having a size of N/2×N/2\hat{ }2 by splitting the second coding unit 2002 in vertical and horizontal directions.

According to an embodiment, the image decoding device 100 may determine the third coding unit 2004, 2014, or 2024 by dividing at least one of a width and height of the second coding unit 2012 having a size of N/2×N. That is, the image decoding device 100 may determine the third coding unit 2004 having a size of N/2×N/2 or the third coding unit 2024 having a size of N/2×N/2\hat{ }2 by splitting the second coding unit 2012 in a horizontal direction, or determine the third coding unit 2014 having a size of N/2\hat{ }2×N/2 by splitting the second coding unit 2012 in vertical and horizontal directions.

According to an embodiment, the image decoding device 100 may determine the third coding unit 2004, 2014, or 2024 by dividing at least one of a width and height of the second coding unit 2022 having a size of N×N/2. That is, the image decoding device 100 may determine the third coding unit 2004 having a size of N/2×N/2 or the third coding unit 2014 having a size of N/2\hat{ }2×N/2 by splitting the second coding unit 2022 in a vertical direction, or determine the third coding unit 2024 having a size of N/2×N/2\hat{ }2 by splitting the second coding unit 2022 in vertical and horizontal directions.

According to an embodiment, the image decoding device 100 may split the square coding unit 2000, 2002, or 2004 in a horizontal or vertical direction. For example, the image decoding device 100 may determine the first coding unit 2010 having a size of N×2N by splitting the first coding unit 2000 having a size of 2N×2N in a vertical direction, or determine the first coding unit 2020 having a size of 2N×N by splitting the first coding unit 2000 in a horizontal direction. According to an embodiment, when a depth is determined based on the length of the longest side of a coding unit, a depth of a coding unit determined by splitting the first coding unit 2000, 2002 or 2004 having a size of 2N×2N in a horizontal or vertical direction may be the same as the depth of the first coding unit 2000, 2002, or 2004.

According to an embodiment, a width and height of the third coding unit 2014 or 2024 may be ½\hat{ }2 times those of the first coding unit 2010 or 2020. When a depth of the first coding unit 2010 or 2020 is D, a depth of the second coding unit 2012 or 2022, the width and height of which are ½ times those of the first coding unit 2010 or 2020, may be D+1, and a depth of the third coding unit 2014 or 2024, the width and height of which are ½\hat{ }2 times those of the first coding unit 2010 or 2020, may be D+2.

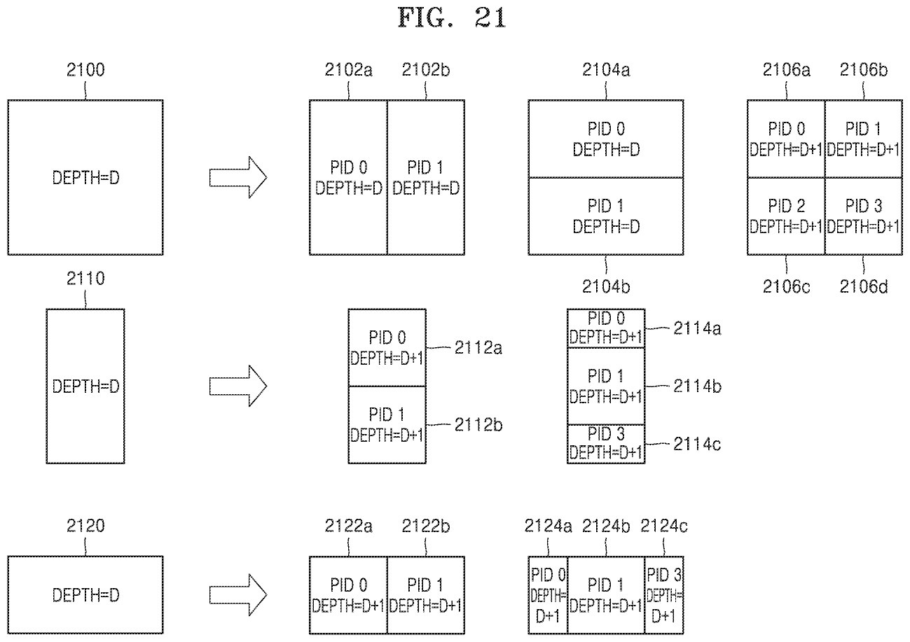

FIG. 21 illustrates depths of and part indices (PIDs) for distinguishing coding units, which may be determined based on the shapes and sizes of the coding units, according to an embodiment.

According to an embodiment, the image decoding device 100 may determine various-shaped second coding units by splitting a square first coding unit 2100. Referring to FIG. 21, the image decoding device 100 may determine second coding units 2102a, 2102b, 2104a, 2104b, 2106a, 2106b, 2106c, and 2106d by splitting the first coding unit 2100 in at least one of vertical and horizontal directions based on split shape information. That is, the image decoding device 100 may determine the second coding units 2102a, 2102b, 2104a, 2104b, 2106a, 2106b, 2106c, and 2106d based on the split shape information of the first coding unit 2100.

According to an embodiment, a depth of the second coding units 2102a, 2102b, 2104a, 2104b, 2106a, 2106b, 2106c, and 2106d, which are determined based on the split shape information of the square first coding unit 2100, may be determined based on the length of a long side thereof. For example, since the length of a side of the square first coding unit 2100 equals the length of a long side of the non-square second coding units 2102a, 2102b, 2104a, and 2104b, the first coding unit 2100 and the non-square second coding units 2102a, 2102b, 2104a, and 2104b may have the same depth, e.g., D. However, when the image decoding device 100 splits the first coding unit 2100 into the four square second coding units 2106a, 2106b, 2106c, and 2106d based on the split shape information, since the length of a side of the square second coding units 2106a, 2106b, 2106c, and 2106d is ½ times the length of a side of the first coding unit 2100, a depth of the second coding units 2106a, 2106b, 2106c, and 2106d may be D+1 which is deeper than the depth D of the first coding unit 2100 by 1.

According to an embodiment, the image decoding device 100 may determine a plurality of second coding units 2112a, 2112b, 2114a, 2114b, and 2114c by splitting a first coding unit 2110, a height of which is longer than a width, in a horizontal direction based on the split shape information. According to an embodiment, the image decoding device 100 may determine a plurality of second coding units 2122a, 2122b, 2124a, 2124b, and 2124c by splitting a first coding unit 2120, a width of which is longer than a height, in a vertical direction based on the split shape information.

According to an embodiment, a depth of the second coding units 2112a, 2112b, 2114a, 2114b, 2114c, 2122a, 2122b, 2124a, 2124b, and 2124c, which are determined based on the split shape information of the non-square first coding unit 2110 or 2120, may be determined based on the length of a long side thereof. For example, since the length of a side of the square second coding units 2112a and 2112b is ½ times the length of a long side of the first coding unit 2110 having a non-square shape, a height of which is longer than a width, a depth of the square second coding units 2112a and 2112b is D+1 which is deeper than the depth D of the non-square first coding unit 2110 by 1.

Furthermore, the image decoding device 100 may split the non-square first coding unit 2110 into an odd number of second coding units 2114a, 2114b, and 2114c based on the split shape information. The odd number of second coding units 2114a, 2114b, and 2114c may include the non-square second coding units 2114a and 2114c and the square second coding unit 2114b. In this case, since the length of a long side of the non-square second coding units 2114a and 2114c and the length of a side of the square second coding unit 2114b are ½ times the length of a long side of the first coding unit 2110, a depth of the second coding units 2114a, 2114b, and 2114c may be D+1 which is deeper than the depth D of the non-square first coding unit 2110 by 1. The image decoding device 100 may determine depths of coding units split from the first coding unit 2120 having a non-square shape, a width of which is longer than a height, by using the above-described method of determining depths of coding units split from the first coding unit 2110.

According to an embodiment, the image decoding device 100 may determine PIDs for identifying split coding units, based on a size ratio between the coding units when an odd number of split coding units do not have equal sizes. Referring to FIG. 21, a coding unit 2114b of a center location among an odd number of split coding units 2114a, 2114b, and 2114c may have a width equal to that of the other coding units 2114a and 2114c and a height which is two times that of the other coding units 2114a and 2114c. That is, in this case, the coding unit 2114b at the center location may include two of the other coding unit 2114a or 2114c. Therefore, assuming that a PID of the coding unit 2114b at the center location is 1 based on a scan order, a PID of the coding unit 2114c located next to the coding unit 2114b may be increased by 2 and thus may be 3. That is, discontinuity in PID values may be present. According to an embodiment, the image decoding device 100 may determine whether an odd number of split coding units do not have equal sizes, based on whether discontinuity is present in PIDs for identifying the split coding units.

According to an embodiment, the image decoding device 100 may determine whether to use a specific splitting method, based on PID values for identifying a plurality of coding units determined by splitting a current coding unit. Referring to FIG. 21, the image decoding device 100 may determine an even number of coding units 2112a and 2112b or an odd number of coding units 2114a, 2114b, and 2114c by splitting the first coding unit 2110 having a rectangular shape, a height of which is longer than a width. The image decoding device 100 may use PIDs to identify a plurality of coding units. According to an embodiment, the PID may be obtained from a sample of a predetermined location of each coding unit (e.g., a top left sample).

According to an embodiment, the image decoding device 100 may determine a coding unit at a predetermined location from among the split coding units, by using the PIDs for distinguishing the coding units. According to an embodiment, when the split shape information of the first coding unit 2110 having a rectangular shape, a height of which is longer than a width, indicates to split a coding unit into three coding units, the image decoding device 100 may split the first coding unit 2110 into three coding units 2114a, 2114b, and 2114c. The image decoding device 100 may assign a PID to each of the three coding units 2114a, 2114b, and 2114c. The image decoding device 100 may compare PIDs of an odd number of split coding units to determine a coding unit at a center location from among the coding units. The image decoding device 100 may determine the coding unit 2114b having a PID corresponding to a middle value among the PIDs of the coding units, as the coding unit at the center location from among the coding units determined by splitting the first coding unit 2110. According to an embodiment, the image decoding device 100 may determine PIDs for distinguishing split coding units, based on a size ratio between the coding units when the split coding units do not have equal sizes. Referring to FIG. 21, the coding unit 2114b generated by splitting the first coding unit 2110 may have a width equal to that of the other coding units 2114a and 2114c and a height which is two times that of the other coding units 2114a and 2114c. In this case, assuming that the PID of the coding unit 2114b at the center location is 1, the PID of the coding unit 2114c located next to the coding unit 2114b may be increased by 2 and thus may be 3. When the PID is not uniformly increased as described above, the image decoding device 100 may determine that a coding unit is split into a plurality of coding units including a coding unit having a size different from that of the other coding units. According to an embodiment, when the split shape information indicates to split a coding unit into an odd number of coding units, the image decoding device 100 may split a current coding unit in such a manner that a coding unit of a predetermined location among an odd number of coding units (e.g., a coding unit of a centre location) has a size different from that of the other coding units. In this case, the image decoding device 100, may determine the coding unit of the centre location, which has a different size, by using PIDs of the coding units. However, the PIDs and the size or location of the coding unit of the predetermined location are not limited to the above-described examples, and various PIDs and various locations and sizes of coding units may be used.

According to an embodiment, the image decoding device 100 may use a predetermined data unit where a coding unit starts to be recursively split.

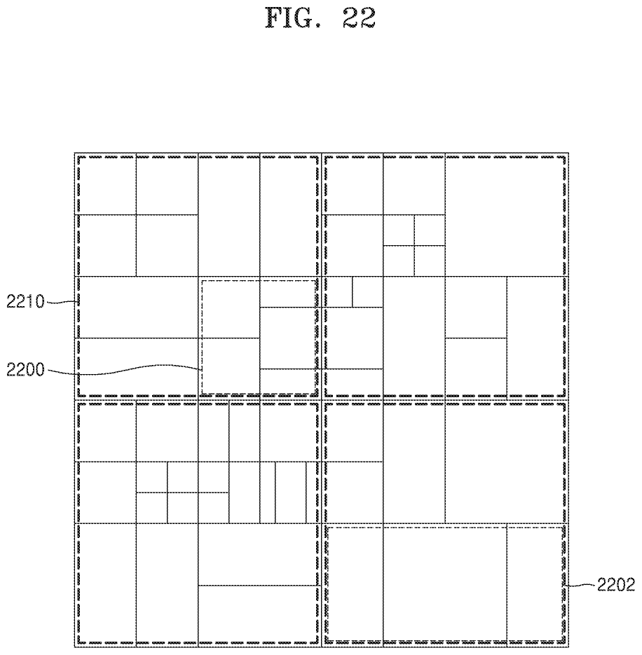

FIG. 22 illustrates that a plurality of coding units are determined based on a plurality of predetermined data units included in a picture, according to an embodiment.

According to an embodiment, a predetermined data unit may be defined as a data unit where a coding unit starts to be recursively split by using at least one of block shape information and split shape information. That is, the predetermined data unit may correspond to a coding unit of an uppermost depth, which is used to determine a plurality of coding units split from a current picture. In the following description, for convenience of explanation, the predetermined data unit is referred to as a reference data unit.

According to an embodiment, the reference data unit may have a predetermined size and shape. According to an embodiment, a reference coding unit may include M×N samples. Herein, M and N may be equal values, and may be integers expressed as multipliers of 2. That is, the reference data unit may have a square or non-square shape, and may be an integer number of coding units.

According to an embodiment, the image decoding device 100 may split the current picture into a plurality of reference data units. According to an embodiment, the image decoding device 100 may split the plurality of reference data units, which are split from the current picture, by using splitting information of each reference data unit. The operation of splitting the reference data unit may correspond to a splitting operation using a quad-tree structure.

According to an embodiment, the image decoding device 100 may previously determine the minimum size allowed for the reference data units included in the current picture. As such, the image decoding device 100 may determine various reference data units having sizes equal to or greater than the minimum size, and determine one or more coding units by using the block shape information and the split shape information with reference to the determined reference data unit.

Referring to FIG. 22, the image decoding device 100 may use a square reference coding unit 2200 or a non-square reference coding unit 2202. According to an embodiment, the shape and size of reference coding units may be determined based on various data units capable of including one or more reference coding units (e.g., sequences, pictures, slices, slice segments, and largest coding units).

According to an embodiment, the receiver of the image decoding device 100 may obtain, from a bitstream, at least one of reference coding unit shape information and reference coding unit size information with respect to each of the various data units. An operation of splitting the square reference coding unit 2200 into one or more coding units has been described above in relation to the operation of splitting the current coding unit 1000 of FIG. 10, and an operation of splitting the non-square reference coding unit 2202 into one or more coding units has been described above in relation to the operation of splitting the current coding unit 1100 or 1150 of FIG. 11. Thus, detailed descriptions thereof will not be provided herein.

According to an embodiment, the image decoding device 100 may use a PID for identifying the size and shape of reference coding units, to determine the size and shape of reference coding units according to some data units previously determined based on a predetermined condition. That is, the receiver may obtain, from the bitstream, only the PID for identifying the size and shape of reference coding units with respect to each slice, slice segment, or largest coding unit which is a data unit satisfying a predetermined condition (e.g., a data unit having a size equal to or smaller than a slice) among the various data units (e.g., sequences, pictures, slices, slice segments, and largest coding units). The image decoding device 100 may determine the size and shape of reference data units with respect to each data unit, which satisfies the predetermined condition, by using the PID. When the reference coding unit shape information and the reference coding unit size information are obtained and used from the bitstream with respect to each data unit having a relatively small size, since efficiency of using the bitstream may not be good, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding device 100 may determine at least one of the size and shape of reference coding units included in a data unit serving as a unit for obtaining the PID, by selecting the previously determined at least one of the size and shape of reference coding units based on the PID.

According to an embodiment, the image decoding device 100 may use one or more reference coding units included in a largest coding unit. That is, a largest coding unit split from a picture may include one or more reference coding units, and coding units may be determined by recursively splitting each reference coding unit. According to an embodiment, at least one of a width and height of the largest coding unit may be integer times at least one of the width and height of the reference coding units. According to an embodiment, the size of reference coding units may be obtained by splitting the largest coding unit n times based on a quad-tree structure. That is, the image decoding device 100 may determine the reference coding units by splitting the largest coding unit n times based on a quad-tree structure, and split the reference coding unit based on at least one of the block shape information and the split shape information according to various embodiments.

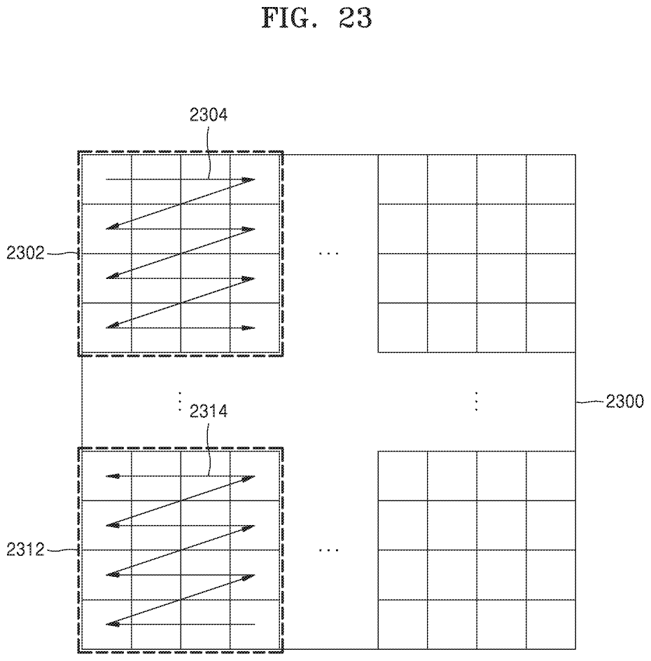

FIG. 23 illustrates a processing block serving as a unit for determining a determination order of reference coding units included in a picture 2300, according to an embodiment.

According to an embodiment, the image decoding device 100 may determine one or more processing blocks split from a picture. The processing block is a data unit including one or more reference coding units split from a picture, and the one or more reference coding units included in the processing block may be determined in a specific order. That is, a determination order of one or more reference coding units determined in each processing block may correspond to one of various types of orders for determining reference coding units, and may vary depending on the processing block. The determination order of reference coding units, which is determined with respect to each processing block, may be one of various orders, e.g., a raster scan order, a Z-scan order, an N-scan order, an up-right diagonal scan order, a horizontal scan order, and a vertical scan order, but is not limited to the above-mentioned scan orders.

According to an embodiment, the image decoding device 100 may obtain processing block size information and determine the size of one or more processing blocks included in the picture. The image decoding device 100 may obtain the processing block size information from a bitstream and determine the size of one or more processing blocks included in the picture. The size of processing blocks may be a predetermined size of data units, which is indicated by the processing block size information.

According to an embodiment, the receiver of the image decoding device 100 may obtain the processing block size information from the bitstream with respect to each specific data unit. For example, the processing block size information may be obtained from the bitstream in a data unit such as image, sequence, picture, slice, or slice segment. That is, the receiver may obtain the processing block size information from the bitstream with respect to each of the various data units, and the image decoding device 100 may determine the size of one or more processing blocks, which are split from the picture, by using the obtained processing block size information. The size of processing blocks may be integer times that of the reference coding units.

According to an embodiment, the image decoding device 100 may determine the size of processing blocks 2302 and 2312 included in the picture 2300. For example, the image decoding device 100 may determine the size of processing blocks based on the processing block size information obtained from the bitstream. Referring to FIG. 23, according to an embodiment, the image decoding device 100 may determine a width of the processing blocks 2302 and 2312 to be four times the width of the reference coding units, and determine a height of the processing blocks 2302 and 2312 to be four times the height of the reference coding units. The image decoding device 100 may determine a determination order of one or more reference coding units in one or more processing blocks.

According to an embodiment, the image decoding device 100 may determine the processing blocks 2302 and 2312, which are included in the picture 2300, based on the size of processing blocks, and determine a determination order of one or more reference coding units in the processing blocks 2302 and 2312. According to an embodiment, determination of reference coding units may include determination of the size of reference coding units.

According to an embodiment, the image decoding device 100 may obtain, from the bitstream, determination order information of one or more reference coding units included in one or more processing blocks, and determine a determination order to one or more reference coding units based on the obtained determination order information. The determination order information may be defined as an order or direction for determining the reference coding units in the processing block. That is, the determination order of reference coding units may be independently determined with respect to each processing block.

According to an embodiment, the image decoding device 100 may obtain the determination order information of reference coding units from the bitstream with respect to each specific data unit. For example, the receiver may obtain the determination order information of reference coding units from the bitstream with respect to each data unit such as image, sequence, picture, slice, slice segment, or processing block. Since the determination order information of reference coding units indicates an order for determining reference coding units in a processing block, the determination order information may be obtained with respect to each specific data unit including an integer number of processing blocks.

According to an embodiment, the image decoding device 100 may determine one or more reference coding units based on the determined determination order.

According to an embodiment, the receiver may obtain the determination order information of reference coding units from the bitstream as information related to the processing blocks 2302 and 2312, and the image decoding device 100 may determine a determination order of one or more reference coding units included in the processing blocks 2302 and 2312 and determine one or more reference coding units, which are included in the picture 2300, based on the determination order. Referring to FIG. 23, the image decoding device 100 may determine determination orders 2304 and 2314 of one or more reference coding units in the processing blocks 2302 and 2312, respectively. For example, when the determination order information of reference coding units is obtained with respect to each processing block, different types of the determination order information of reference coding units may be obtained for the processing blocks 2302 and 2312. When the determination order 2304 of reference coding units in the processing block 2302 is a raster scan order, reference coding units included the processing block 2302 may be determined in a raster scan order. Unlike this, when the determination order 2314 of reference coding units in the other processing block 2312 is an inverse raster scan order, reference coding units included in the processing block 2312 may be determined in an inverse raster scan order.

According to an embodiment, the image decoding device 100 may decode the determined one or more reference coding units. The image decoding device 100 may decode the picture based on the reference coding units determined as described above. A method of decoding the reference coding units may include various image decoding methods.

According to an embodiment, the image decoding device 100 may obtain block shape information indicating the shape of a current coding unit or split shape information indicating a splitting method of the current coding unit, from the bitstream, and use the obtained information. The block shape information or the split shape information may be included in the bitstream related to various data units. For example, the image decoding device 100 may use the block shape information or the split shape information included in a sequence parameter set, a picture parameter set, a video parameter set, a slice header, or a slice segment header. Furthermore, the image decoding device 100 may obtain syntax corresponding to the block shape information or the split shape information from the bitstream with respect to each largest coding unit, reference coding unit, or processing block, and use the obtained syntax.

While the present disclosure has been particularly shown and described with reference to embodiments thereof, it will be understood by one of ordinary skill in the art that various changes in form and details may be made therein without departing from the scope of the disclosure as defined by the following claims. The embodiments should be considered in a descriptive sense only and not for purposes of limitation. Therefore, the scope of the disclosure is defined not by the detailed description of the disclosure but by the following claims, and all differences within the scope will be construed as being included in the present disclosure.

Meanwhile, the afore-described embodiments of the present disclosure can be written as computer programs and can be implemented in general-use digital computers that execute the programs by using a computer-readable recording medium. Examples of the computer-readable recording medium include magnetic storage media (e.g., ROM, floppy disks, hard disks, etc.), optical recording media (e.g., CD-ROMs, or DVDs), etc.

1. A method of decoding an image, the method comprising:
obtaining a residual signal of the image from a bitstream;
changing a ratio of sizes of adjacent first blocks among a plurality of first blocks including the residual signal, based on block ratio information obtained from the bitstream; and
decoding the residual signal, based on the changed ratio,
wherein the block ratio information indicates one of predetermined ratios to which the ratio of the sizes of the adjacent first blocks is changeable.

2. The method of claim 1, wherein the changing of the ratio of the sizes of the adjacent first blocks comprises:
obtaining, from the bitstream, size change information indicating whether the ratio of the sizes of the adjacent first blocks is to be changed; and
when the size change information indicates that the ratio of the sizes of the adjacent first blocks is to be changed, changing the ratio of the sizes of the adjacent first blocks, based on the block ratio information.

3. The method of claim 2, wherein the block ratio information is obtained from the bitstream when the size change information indicates that the ratio of the sizes of the adjacent first blocks is to be changed.

4. The method of claim 1, wherein the changing of the ratio of the sizes of the adjacent first blocks comprises:
obtaining the block ratio information, from the bitstream, in units of second blocks each including the adjacent first blocks; and
when the block ratio information indicates that a ratio of sizes of the adjacent first blocks included in each of the second blocks is to be changed, changing the ratio of the sizes of the adjacent first blocks included in each of the second blocks, based on the block ratio information.

5. The method of claim 1, wherein the plurality of first blocks comprise transformation units for inversely transforming the residual signal.

6. The method of claim 4, wherein the second blocks comprise largest coding units, coding units, or prediction units each including the adjacent first blocks, or processing blocks including at least one of the largest coding units.

7. A method of encoding an image, the method comprising:
determining a residual signal of the image;
changing a ratio of sizes of adjacent first blocks among a plurality of first blocks including the residual signal; and
encoding the image by generating a bitstream including the residual signal and block ratio information, based on the changed ratio, wherein the block ratio information indicates the changed ratio,
wherein the block ratio information indicates one of predetermined ratios to which the ratio of the sizes of the adjacent first blocks is changeable.

8. The method of claim 7, wherein the changing of the ratio of the sizes of the adjacent first blocks comprises:
determining whether the ratio of the sizes of the adjacent first blocks is to be changed; and
when it is determined that the ratio of the sizes of the adjacent first blocks is to be changed, changing the ratio of the sizes of the adjacent first blocks.

9. The method of claim 8, wherein the encoding of the image by generating the bitstream comprises:
generating a bitstream including size change information indicating whether the ratio of the sizes of the adjacent first blocks is to be changed; and
when it is determined that the ratio of the sizes of the adjacent first blocks is to be changed, encoding the image by generating a bitstream including the block ratio information.

10. The method of claim 7, wherein the changing of the ratio of the sizes of the adjacent first blocks comprises:
when it is determined that a ratio of sizes of the adjacent first blocks included in each of second blocks is to be changed, changing the ratio of the sizes of the adjacent first blocks included in each of the second blocks, based on the block ratio information; and
generating the bitstream including the block ratio information in units of the second blocks each including the adjacent first blocks.

11. The method of claim 7, wherein the plurality of first blocks comprise transformation units for transforming or inversely transforming the residual signal.

12. The method of claim 10, wherein the second blocks comprise largest coding units, coding units or prediction units including the adjacent first blocks, or processing blocks including at least one of the largest coding units.

13. A device for decoding an image, the device comprising:
a signal obtainer configured to obtain a residual signal of the image from a bitstream; and
a decoder configured to change a ratio of sizes of adjacent first blocks among a plurality of first blocks including the residual signal, based on block ratio information obtained from the bitstream, and decode the residual signal, based on the changed ratio,
wherein the block ratio information indicates one of predetermined ratios to which the ratio of the sizes of the adjacent first blocks is changeable.

14. (canceled)

15. A non-transitory computer-readable recording medium having recorded thereon a computer program for executing the method of claim 1.
